(19) United States
(12) Patent Application Publication
(10) Pub. No.: US 2016/0203505 A1
(43) Pub. Date: Jul. 14, 2016

(54) NETWORK SHOPPING SYSTEM AND ASSOCIATED IMPLEMENTATION METHOD

(71) Applicant: Here2Shop, Inc., Taipei City (TW)

(72) Inventors: Ming-Hsun LIU, Taipei City (TW); Chao-Chi CHANG, Taipei City (TW)

(21) Appl. No.: 14/818,142

(22) Filed: Aug. 4, 2015

(30) Foreign Application Priority Data
Jan. 12, 2015 (TW) 104100936
Apr. 9, 2015 (TW) 104111378

(51) Int. Cl. G06Q 30/02; G06Q 50/00

(52) U.S. Cl. CPC G06Q 30/0214; G06Q 50/01; G06Q 30/0222

(57) ABSTRACT

A network shopping system and an associated implementation method are provided. The network shopping system and the associated implementation method are capable of determining qualified registered members for sharing merchandise profit of purchased products upon completing a specific shopping action. Furthermore, the conditions for the credit-calculation mechanism in the network shopping system can be dynamically adjusted based on the hierarchy network of the registered member and the specific shopping action being completed by the registered member.

### CROSS REFERENCE TO RELATED APPLICATIONS

This application claims priority of Taiwan Patent Application No. 104100936, filed on Jan. 12, 2015 and Taiwan Patent Application No. 104111378; filed on Apr. 9, 2015, the entirety of which are incorporated by reference herein.

### BACKGROUND OF THE INVENTION

1. Field of the Invention

The present invention relates to a network shopping system having a credit-calculation mechanism and associated implementation method, and, in particular, to a network shopping system and associated implementation method capable of determining qualified registered members for sharing merchandise profit of purchased products upon completing a specific shopping action.

2. Description of the Related Art

Shopping on the Internet is very convenient for consumers, and it has become one of the favorite shopping actions of consumers. Based on the statistical results from the “Research, Development, and Evaluation Commission of the Executive Yuan”, 62.7% of Internet users have purchased products on the Internet. Accordingly, shopping on the Internet has become very popular, and many electronic business platforms have been developed, such as running B2B, B2C, and C2C business models. In order to raise interest among potential buyers to purchase products on a network shopping platform, the network shopping platform industry often provides different offers, and reward points are frequently used. When the consumer has purchased products for a certain amount of money, the consumer may gain reward points, and the reward points can be redeemed for discounts within a limited period.

However, network shopping systems using a mechanism of providing bonus or reward points may have the following disadvantages: (1) the consumer has to send the recommendation message or invitations to friends via email, or publicize the information of the products on a social networking website. However, the consumer is less willing to share or recommend products because it may be annoying for his friends; (2) the referral has to provide the recommender's data (e.g. account) and complete purchasing, and only then the recommender can successfully redeem the rewards; (3) hierarchy levels of users can be confirmed through social networking websites or be built according to recommendation messages. However, the hierarchy levels are usually fixed, and the user cannot dynamically select friends to share the profit of the purchased product; (4) the conditions in the credit-calculation mechanism are inflexible, and the user cannot alternate the conditions for credit-calculation, such as increasing the profit ratio or extending the validity period for credit-calculation.

### BRIEF SUMMARY OF THE INVENTION

In view of the aforementioned problems, a network shopping system and an associated implementation method is provided in the invention. The network shopping system and the associated implementation method provide a credit-calculationmechanism capable of dynamically alternating the condition for credit-calculation according to a membership hierarchy network of the registered members and their shopping action.

In an exemplary embodiment, a network shopping system having a credit-calculation mechanism is provided. The network shopping system comprises: a merchandise management module, configured to receive merchandise data of at least one product for sale and merchandise profit of the product registered by an administrator, and generate a merchandise data table comprising the merchandise data and the merchandise profit; a membership management module, configured to analyze and confirm friend relationships between a plurality of registered members of the network shopping system, and traverse a member hierarchy network according to the friend relationship between the registered members; a merchandise shopping module, information-linked with the merchandise management module and the membership management module, and configured to receive shopping data and a specific shopping action when the registered members purchase the product, and generate a shopping data table comprising the shopping data and the specific shopping action; and a dynamic credit-calculation module, information-linked with the merchandise management module, the membership management module, and the merchandise shopping module, wherein the dynamic credit-calculation module determines a hierarchy network corresponding to the specific shopping action from the membership hierarchy network, and performs a calculation of credits for distributing the merchandise profit of the purchased product according to the hierarchy network.

In another exemplary embodiment, a method for implementing a credit-calculation mechanism in a network shopping system is provided. The method comprises: a merchandise data setting step, a hierarchy network confirmation step, a shopping action recording step, and a merchandise profit calculation step. The merchandise data setting step comprises the steps of: receiving merchandise data of at least one product for sale registered by an administrator via a merchandise registration interface of the network shopping system; receiving settings of merchandise profit of the product for sale via a merchandise profit setting interface of the network shopping system; and generating a merchandise data table comprising the merchandise data and the merchandise profit. The hierarchy network confirmation step comprises the steps of: analyzing and confirming friend relationships between a plurality of registered members of the network shopping system via the network shopping system; and traversing a membership hierarchy network according to the confirmed friend relationship. The shopping action recording step comprises the steps of: recording shopping data and a specific shopping action of the registered members who purchased the product for sale on the network shopping system via a shopping interface of the network shopping system; and generating a shopping data table according to the shopping data and the specific shopping action. The merchandise profit calculation step comprises: determining a hierarchy network corresponding to the specific shopping action from the membership hierarchy network according to the shopping data table, the membership hierarchy network, and the merchandise data table; and calculating credits for sharing the merchandise profit according to the hierarchy network.

### BRIEF DESCRIPTION OF THE DRAWINGS

The present invention can be more fully understood by reading the subsequent detailed description and examples with references made to the accompanying drawings, wherein:

FIG. 1 is a schematic diagram of a network shopping system in accordance with an embodiment of the invention;

FIG. 2 is a diagram showing different configurations for sharing merchandise profits in accordance with an embodiment of the invention;

FIG. 3 is a diagram of a member relationship network in accordance with an embodiment of the invention;

FIG. 4 is a schematic diagram of the shopping recording module in accordance with an embodiment of the invention;

FIG. 5 is a diagram of a shopping record in accordance with an embodiment of the invention;

FIG. 6 is a diagram of a user interface of the network shopping system in accordance with a first embodiment of the invention;

FIG. 7 is a diagram of another user interface in accordance with the first embodiment of the invention;

FIG. 8 is a diagram of a user interface of the network shopping system in accordance with a second embodiment of the invention;

FIG. 9 is a schematic diagram of the shopping recording module 101 in accordance with an embodiment of the invention;

FIG. 10 is another diagram of a shopping record in accordance with an embodiment of the invention;

FIG. 11 is a diagram showing different configurations for sharing merchandise profits in accordance with another embodiment of the invention;

FIG. 12 is a diagram of a user interface of the network shopping system in accordance with a third embodiment of the invention;

FIG. 13 is a diagram of a user interface of the network shopping system in accordance with a fourth embodiment of the invention;

FIG. 14 is yet another diagram of shopping record in accordance with an embodiment of the invention;

FIG. 15 is a diagram of a user interface of the network shopping system 1 in accordance with a fifth embodiment of the invention;

FIG. 16 is yet another diagram of a shopping record in accordance with an embodiment of the invention;

FIG. 17 is a diagram of a user interface in accordance with a sixth embodiment of the invention;

FIG. 18 is a diagram of a user interface in accordance with a seventh embodiment of the invention;

FIG. 19 is a flow chart of a method for implementing the credit-calculationcredit-calculation mechanism in a network shopping system in accordance with an embodiment of the invention;

FIG. 20 is a diagram of the member relationship network in accordance with an embodiment of the invention;

FIGS. 21A˜21I are diagrams of the hierarchy network when registered members purchase the same product in accordance with an embodiment of the invention; and

FIGS. 22A˜22I are diagrams of the hierarchy network when registered members purchase the same product in accordance with an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

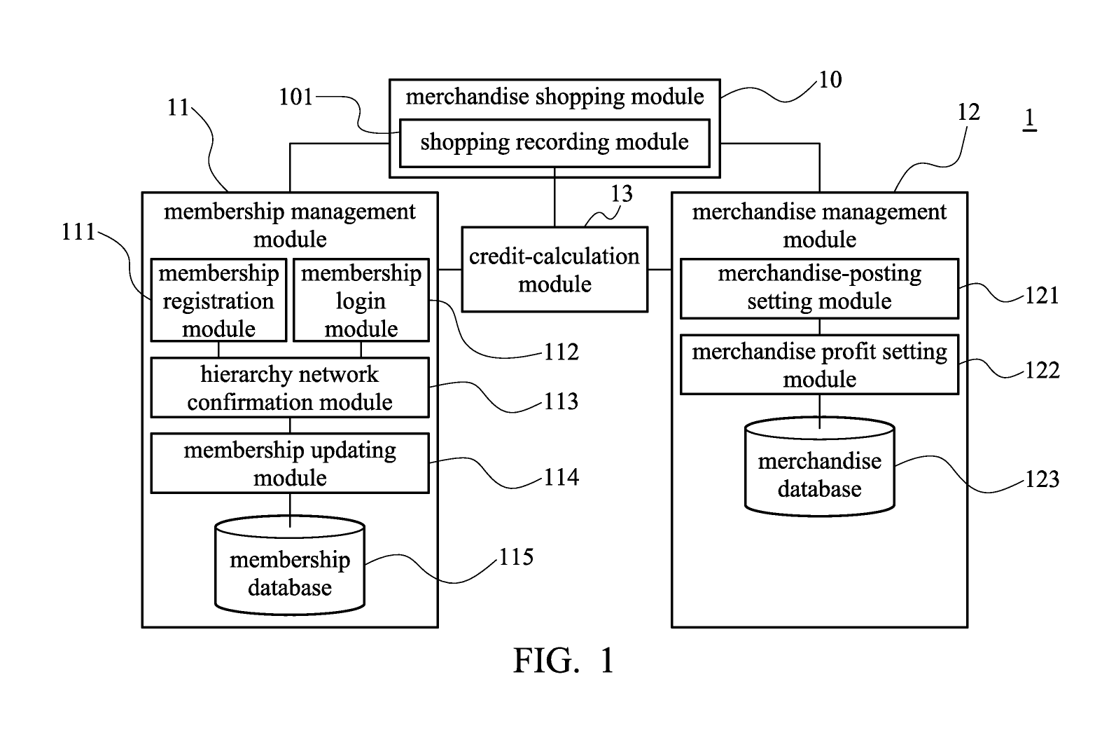

FIG. 1 is a schematic diagram of a network shopping system in accordance with an embodiment of the invention. The network shopping system 1 has a credit-calculation mechanism, and comprises a merchandise shopping module 10, a membership management module 11, a merchandise management module 12, and a dynamic credit-calculation module 13. The merchandise 10 allows a user to connect his electronic device, such as a personal computer, a notebook, a tablet PC, or a smartphone, to the network shopping system, and provides a user interface for the user to view and buy among numerous items of merchandise for sale. In addition, a shopping recording module 101 records shopping data and the shopping action of each user, thereby generating a shopping data table (not shown). In an embodiment, the modules 11˜13 in the network shopping system 1 can be implemented by one or more general-purpose computers or servers.

The membership management module 11 and the merchandise shopping module 10 shares information between each other, and the membership management module 11 comprises a membership registration module 111, a membership login module 112, a hierarchy network confirmation module 113, a membership data updating module 114, and a membership database 115. When a user is shopping in the network shopping system 1 via the merchandise shopping module 10 for the first time, the membership registration module 111 of the membership management module 11 then asks the user for required data such as the membership account, password, phone number, contact address, and social network data (e.g. social network account), but the invention is not limited thereto. Upon completion of registration, the user becomes a registered member of the network shopping system 1. The registered user may log onto the network shopping system 1 via the membership login module 112, and then purchase merchandise for sale via the merchandise shopping module 10. The hierarchy network confirmation module 113 shares information with the membership registration module 111 and the membership login module 112, and is configured to confirm friend relationships between the registered members. In addition, the hierarchy network confirmation module 113 further traverses in a member relationship network (i.e. shown in FIG. 20) to confirm the friend relationship between each registered member, and then records the friend relationship with nodes and edges in the membership database 115. The friend relationship between two registered members is recorded by an edge. For example, the membership data of member A records A-C and A-D, and it indicates that member A and member C are friends, and member A and member D are friends. Accordingly, the network hierarchy confirmation module 113 may traverse each and every edge and node in the member relationship network, thereby analyzing and confirming the friend relationship of each registered member. It should be noted that the recorded friend relationship is not limited to the node-edge format, and can be recorded in a graphics database or similar formats. The membership data updating module 114 shares information with the hierarchy network confirmation module 113 and the membership database 115, and is configured to update the data (e.g. passwords, member relationship network, etc.) of the registered members, and store the updated data into the membership database 115.

The merchandise management module 12 shares information with the merchandise shopping module 10, and the merchandise management module 12 comprises a merchandise-posting setting module 121, a merchandise profit setting module 122, and a merchandise database 123. The merchandise-posting setting module 121 is configured to provide a user interface for the suppliers or retailers to register detailed data of merchandise for sale, such as a picture, product name, price, category, and posting time, but the invention is not limited thereto. Upon completion of registration of the detailed data of the merchandise for sale, the merchandise management module 12 then posts the merchandise for sale on the merchandise shopping module 10, so that the member can view the merchandise for sale on the network shopping system 1.

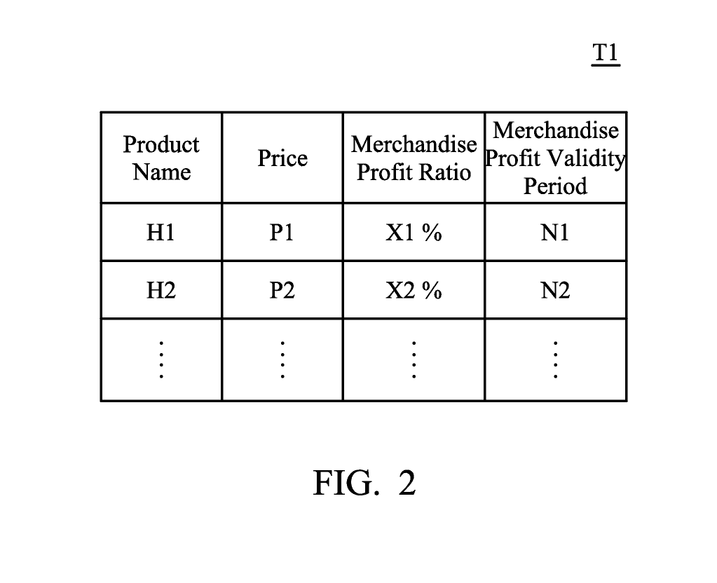

FIG. 2 is a diagram showing different configurations for sharing merchandise profits in accordance with an embodiment of the invention. Referring to FIG. 2, the diagram can be displayed as a user interface to set up the configurations for sharing merchandise profits. For example, in addition to the product names (e.g. H1, H2, etc.) and prices (e.g. P1, P2, etc.), the merchandise profit setting module 122 of the merchandise management module 12 further provides different settings of the merchandise profits including the merchandise profit ratios (e.g. X1%, X2%, etc.) and merchandise profit validity period (e.g. N1, N2, etc). That is, the credit for sharing the profit of each item of merchandise can be set for the registered members, where X1 and X2 are non-zero positive numbers (e.g. 1%, 3.5%, or 10%, but not limited thereto). In addition, the aforementioned merchandise profit can a virtual item, a virtual currency, physical items, and physical currency, or a combination thereof.

For example, given that the merchandise for sale has a product name H1 and a price P1, when the merchandise profit ratio is set to X1%, the credit for sharing the merchandise profit is P1*X1%. In addition, the aforementioned merchandise profit validity period indicates the period that the registered member can earn the merchandise profit. In a preferred embodiment, the unit of the period is in days, and can also be in months or years, but the invention is not limited thereto. The numbers N1 and N2 are non-zero positive integers (e.g. the period may be 1 day, 2 days, 1 month, 2 months, 1 year, etc). In addition, the merchandise profit validity period (e.g. N1, N2) starts from the time at which the registered member has completed a specific shopping action. For example, given that the period is set to N2 and N2 is 10 days, when the registered member has completed his purchase of the merchandise H2 on Nov. 13, 2013, the merchandise profit validity period lasts 10 days, which starts from Nov. 13, 2013 to Nov. 23, 2013. At last, a merchandise data table T1 comprising the merchandise profit ratio and the merchandise profit validity period of each item of merchandise for sale is stored into the merchandise database 123.

The dynamic credit-calculation module 13 is configured to perform a calculation of the credit-calculation mechanism of merchandise profits. When a registered member has completed his purchase of one of the items of merchandise, the dynamic credit-calculation module 13 performs a calculation of the credit-calculation credits of the qualified registered members according to the shopping data table of the registered members, the member relationship network, and the merchandise data table T1. Then, the dynamic credit-calculation module 13 updates and stores the data of the registered members into the membership database 115 via the membership data updating module 114.

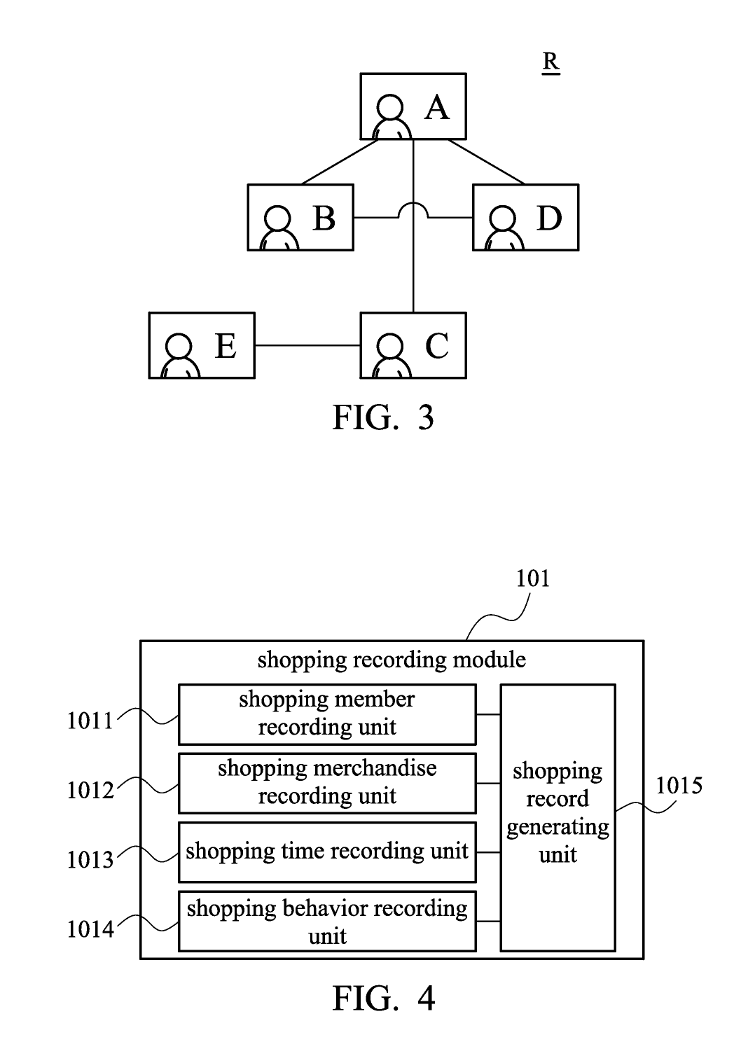

FIG. 3 is a diagram of a member relationship network in accordance with an embodiment of the invention. The hierarchy network confirmation module 113 builds and confirms the member relationship network R. In a preferred embodiment, the hierarchy network confirmation module 113 uses “single-direction confirmation” in the member relationship network R to confirm the friend relationship of each registered member. That is, when users register with the network shopping system 1 via the membership registration module 111, each user may freely select some registered members as friends. For example, registered member B selects registered members A and D as friends upon registration. Also, both registered members C and D select registered member A as a friend upon registration. In addition, registered member E selects registered member C as a friend. Accordingly, the hierarchy network confirmation module 113 binds registered member A with registered members B, C, and D, and binds registered member B with registered members A and D. The binding of the registered members recorded by the hierarchy network confirmation module 113 are in the format of node-edge, and the hierarchy network confirmation module 113 builds the member relationship network R according to the bindings, and traverses the member relationship network R to confirm the friend relationship of each registered member. In addition, the hierarchy network confirmation module 113 may also use “two-direction confirmation” in the member relationship network R to confirm the friend relationship of each registered member. That is, when a registered user selects other registered members as friends, the hierarchy network confirmation module 113 sends a friend relationship confirmation notification to the selected registered members. After the selected registered members confirm the friend relationship, the hierarchy network confirmation module 113 builds the member relationship network R. Furthermore, the hierarchy network confirmation module 113 may also actively connect to external social networking websites, such as FACEBOOK, LinkedIn, Twitter, Google+, according to the social network data provided by the registered members, and analyze their contacts to confirm the friend relationship.

When registered member B has become a friend of registered members A and D on FACEBOOK, the hierarchy network confirmation module 113 may bind registered member B with registered member A, and bind registered member B with registered member D to confirm their friend relationship. In addition, if these social networks are used, the hierarchy network confirmation module 113 may further provide a function for re-confirmation of the member relationship network R. That is, when a registered member has logged onto the network shopping system 1 via the member login module 112, the hierarchy network confirmation module 113 may connect to the external social networking website, and analyze the contacts of the registered member on the social networking website to rebuild and confirm the member relationship network R. Then, the member relationship network R can be updated via the membership data updating module 114. The member relationship network R can be reconfirmed each time the registered member logs into the network shopping module 113 via the membership login module 112, or be reconfirmed periodically (e.g. every week, or every month), but the invention is not limited thereto. In addition, the registered member can also actively alternate his friend relationships with friends via the hierarchy network confirmation module 113. For example, registered member B may remove registered member D from his friend list, and registered members B and D are no longer friends. However, registered member B can also re-add registered member D into his friend list to recover the friend relationship.

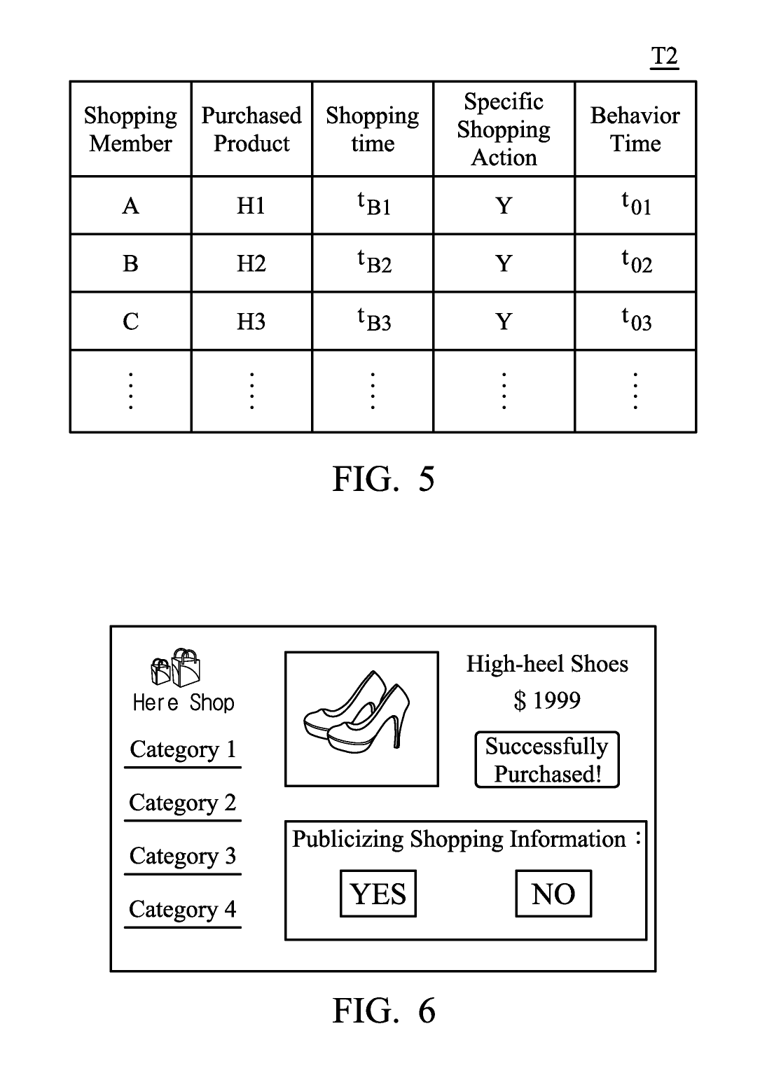

FIG. 4 is a schematic diagram of the shopping recording module in accordance with an embodiment of the invention. The shopping recording module 101 of the merchandise shopping module 10 comprises a shopping member recording unit 1011, a shopping merchandise recording unit 1012, a shopping time recording unit 1013, a shopping action recording unit 1014, and a shopping record generating unit 1015, where units 1011˜1014 share information with the shopping record generating unit 1015. FIG. 5 is a diagram of a shopping record in accordance with an embodiment of the invention. The shopping member recording unit 1011 records the registered members (e.g. A, B, C, etc.) to purchase the merchandise for sale. The shopping merchandise recording unit 1012 records the purchased product of each registered member (e.g. A, B, C, etc.). For example, the product name of the product purchased by registered member A is H1. The shopping time recording unit 1013 records the shopping time (e.g. t_{B1}, t_{B2}, t_{B3}, etc.) of each product (e.g. H1, H2, H3, etc.) purchased by each registered member (e.g. A, B, C, etc.). The shopping action recording unit 1014 records the specific shopping action after any registered member has completed his purchase of the merchandise for sale. If there is a specific shopping action, the data is recorded as “Y”. Otherwise, the data is recorded as “N”. The aforementioned specific shopping action may be behaviors such as publicizing shopping information, sharing shopping information, or recommending merchandise for sale, but the invention is not limited thereto. In an embodiment, the specific shopping action indicates purchasing the merchandise for sale. That is, the specific shopping action is completed without any other operations upon purchasing the merchandise for sale. In addition, the shopping action recording unit 1014 records the behavior time (e.g. t₀₁, t₀₂, t₀₃, etc.) of completing the specific shopping action of each registered member (e.g. A, B, C, etc.). When the specific shopping action indicates purchasing the merchandise for sale, the behavior time is the shopping time. At last, after each recording unit has completed recording, the shopping record generating unit 1015 generates a shopping data table T2 including the shopping members, shopping merchandise, shopping time, specific shopping action, and behavior time. In a preferred embodiment, the shopping data table T2 is stored in the membership database 115.

FIG. 6 is a diagram of a user interface of the network shopping system in accordance with a first embodiment of the invention. In an embodiment, the product name of the high-heel shoes is H1, and the specific shopping action indicates publicizing the shopping information. When registered member C purchases the high-heel shoes via the merchandise shopping module 10, the shopping recording module 101 records the shopping member, the shopping merchandise, and the shopping time. The merchandise shopping module 10 shows a notification on the user interface to ask registered member C whether to publicize the shopping information. If registered member C chooses “Yes”, the shopping action recording module 1014 of the shopping recording module 101 will record the specific shopping action as “Y”, and the behavior time t03 of completing the specific shopping action. Then, registered member C is qualified to obtain the profit of the purchased product H1.

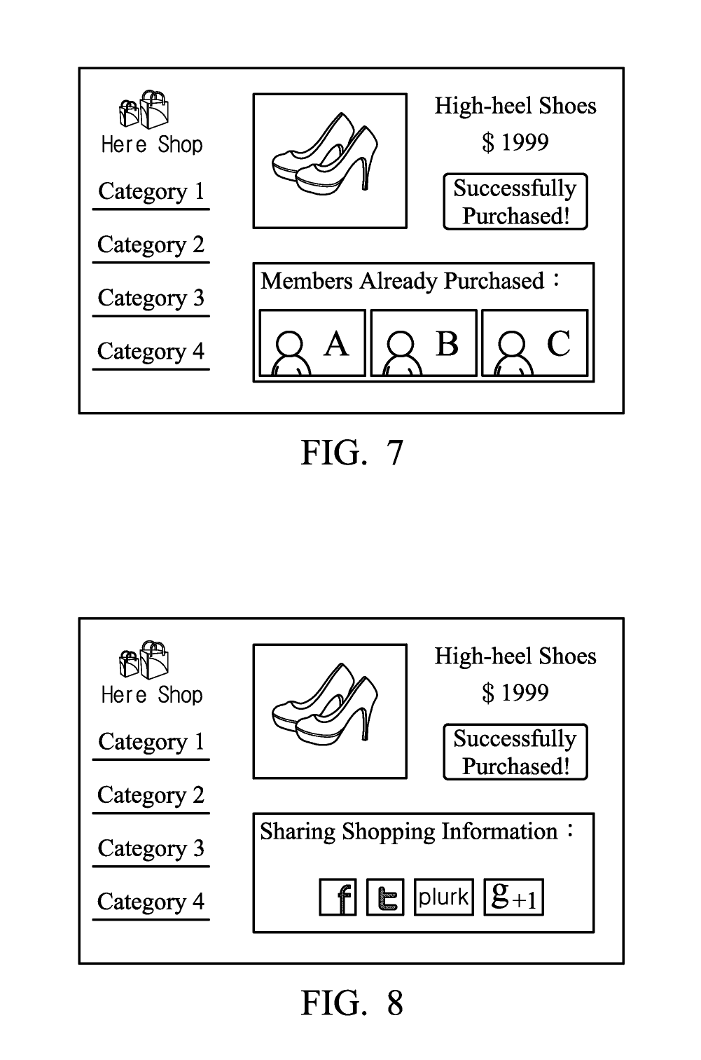

FIG. 7 is a diagram of another user interface in accordance with the first embodiment of the invention. Meanwhile, the information about purchasing the high-heel shoes by registered member C is publicized on the merchandise shopping module 10. When other users are browsing the high-heel shoes H1, they may know whether any other friend has purchased the product. Conversely, if registered member C selects “No”, the shopping action shopping module 1014 of the shopping recording module 101 records the specific shopping action as “N”. It should be noted that registered member C is not qualified to obtain the profit of the purchased product H1 in this situation even if registered member C has already purchased the product H1. Referring to FIG. 6, when registered member C selects “Yes”, registered member C is qualified to obtain the profit of the purchased product, and the dynamic credit-calculation module 13 will perform a calculation of the credit-calculation mechanism according to the merchandise data table T1 (e.g. FIG. 2), the member relationship network R (e.g. FIG. 3), and the shopping data table T2 (e.g. FIG. 5).

The aforementioned calculation includes confirming the purchased products of each registered member in the shopping data table T2, and confirming whether the specific shopping action is completed by matching the behavior time in the shopping data table T2. It should be noted that the primary parameter for confirming whether the specific shopping action is completed can be one of publicizing the shopping information, sharing the shopping information, recommending the product for sale, or shopping for the product for sale. In addition, the parameter for confirming whether the specific shopping action is completed can also be the combination of publicizing the shopping information, sharing the shopping information, recommending the product for sale, or purchasing the product for sale, but the invention is not limited thereto.

For example, the dynamic credit-calculation module 13 may know that registered member A has also purchased the product H1, and registered member A is qualified for obtaining the profit of the purchased product H1 (e.g. the specific shopping action is recorded as “Y”) via the shopping data table T2. Then, the dynamic credit-calculation module 13 may match the behavior time t₀₁ of completing the specific shopping action with the merchandise profit valid time N1 associated with the product H1 in the merchandise data table T1 to confirm whether the behavior time is within the merchandise profit validity period. If the behavior time is within the merchandise profit validity period, the dynamic credit-calculation module 13 further confirms that registered members A and C are friends via the member relationship network R. Then, the dynamic credit-calculation module 13 calculates the credit for sharing the profit of the purchased product by multiplying the price P1 of the product H1 with the merchandise profit ratio X1 in the merchandise data table T1, and updates the membership data of registered member A via the membership data updating module 114, so that registered member A may view his merchandise profit on the network shopping system 1. If registered member C selects “No”, registered member C is not qualified to share the merchandise profit. However, the dynamic credit-calculation module 13 may calculate the credit-calculation for each qualified member again. The calculation procedure for credit-calculation can be referred to in the aforementioned embodiment, and the details will be omitted here.

FIG. 8 is a diagram of a user interface of the network shopping system in accordance with a second embodiment of the invention. In the second embodiment, given that the specific shopping action indicates sharing the shopping information, when registered member C purchases the product H1 via the merchandise shopping module 10, the shopping recording module 101 records the shopping member, the shopping merchandise, and the shopping time, and the merchandise shopping module 10 will ask registered member C whether to share the shopping information. If registered member C shares the shopping information (e.g. publicizing the information about purchasing the product H1 to a social networking websites or a blog), the shopping action recording module 1014 of the shopping recording module 101 will record the specific shopping action as “Y”. Conversely, if registered member C does not share the shopping information, the shopping action recording module 1014 of the shopping recording module 101 will record the specific shopping action as “N”. In addition, the recording of associated shopping data and the subsequent calculation of credit-calculation can be referred to in the aforementioned embodiment, and the details will be omitted here.

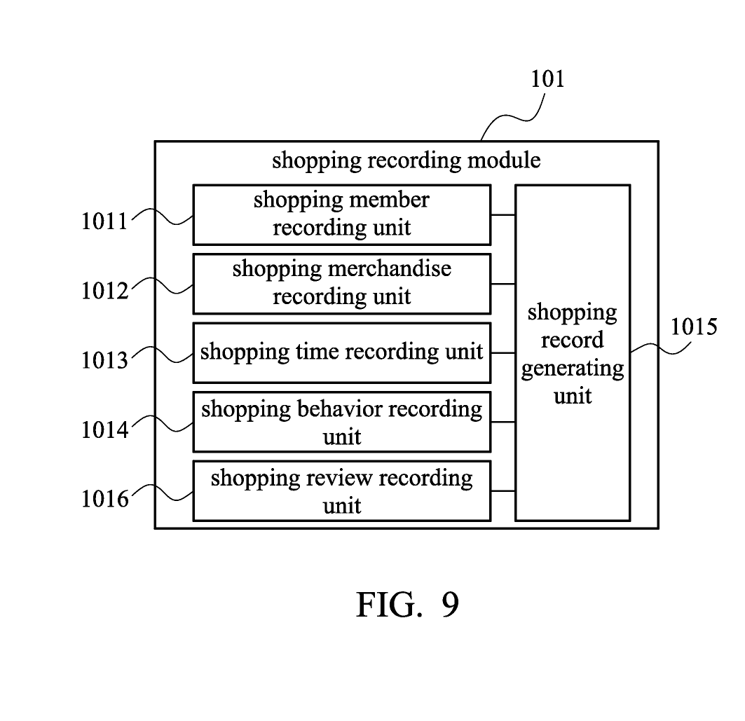

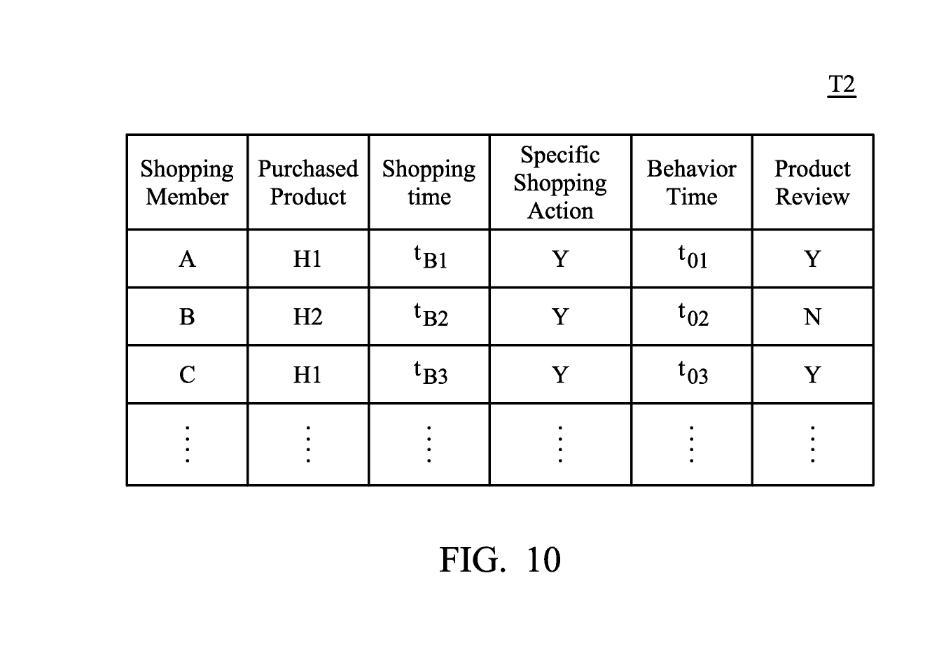

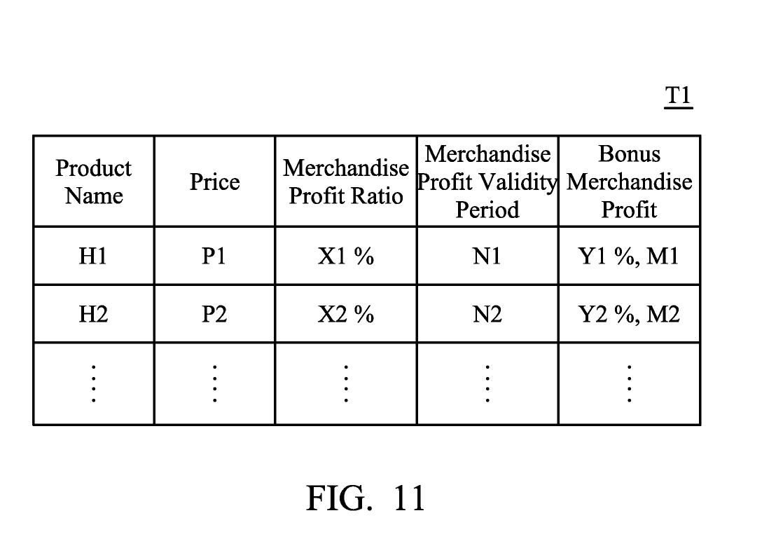

FIG. 9 is a schematic diagram of the shopping recording module 101 in accordance with an embodiment of the invention. Referring to FIGS. 1˜3 and FIG. 9, the shopping recording module 101 further comprises a product review recording unit 1016, which is configured to record the review of the product from the registered member after the registered member has purchased the product. In addition, compared with the specific shopping action such as publicizing the shopping information and sharing the shopping information, writing a product review can be regarded as an additional shopping action. FIG. 10 is another diagram of a shopping record in accordance with an embodiment of the invention. Referring to FIG. 10, when the registered member has written a product review for the purchased product such as rating it with stars or in a text review (not limited), the product review recording unit 1016 will record this reviewing behavior as “Y”. Conversely, the product review recording unit 1016 will record “N” when the registered member does not write any product review. The record of the product reviews is shown in the shopping data table T2. FIG. 11 is a diagram showing different configurations for sharing merchandise profits in accordance with another embodiment of the invention. Referring to FIG. 11, when the retailer is setting the configurations for sharing the profit of the merchandise in the merchandise data table T1, additional configurations for obtaining bonus profit can be set simultaneously. For example, the bonus profit of the product H1 is “Y1%, M1”, and the bonus profit of the product H2 is “Y2%, M2”, where Y1% and Y2% indicate the additional credit of the merchandise profit, and Y1 and Y2 are non-zero positive numbers. M1 and M2 indicate the extended period for the registered member to gain the profit of each product. In a preferred embodiment, M1 and M2 are non-zero positive integers, and can be counted in days, months, or years, but the invention is not limited thereto. It should be noted that when the registered member has completed the specific shopping action (e.g. publicizing the shopping information or sharing the shopping information), the registered member is qualified to gain the original merchandise profit. When the registered member has completed the additional shopping action (e.g. writing a product review), the registered member is further qualified to gain the bonus merchandise profit in the extended period.

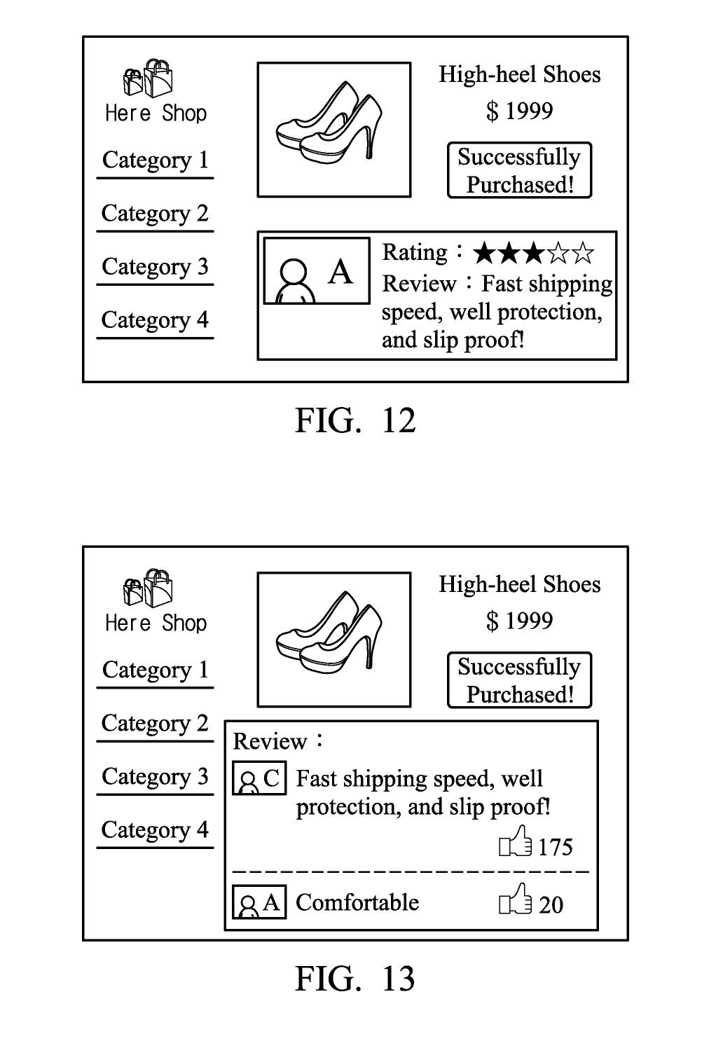

FIG. 12 is a diagram of a user interface of the network shopping system in accordance with a third embodiment of the invention. Referring to FIG. 12, given that registered member A has purchased the product H1, completed the specific shopping action of publicizing the shopping information, and completed the additional shopping action of writing a product review, when registered member A has received the product P1 and written a product review with a 3-star rating and a comment of “Fast shipping speed. Well protected!”, the product review recording unit 1016 of the shopping recording module 101 will record the reviewing behavior of registered member A as “Y” in the shopping data table T2 (e.g. FIG. 10) via the shopping record generating unit 1015. When registered member C has purchased the product H1, the dynamic credit-calculation module 13 will perform a calculation of the mechanism according to the merchandise data table T1, the member relationship network R, and the shopping data table T2. In the calculation, the dynamic credit-calculation module 13 knows that registered member A has also purchased the product H1 through the shopping data table T2, and registered member A is qualified to gain the profit of the purchased product H1 (i.e. the specific shopping action is recorded as “Y”), and is qualified to gain the bonus profit of the purchased product H1 in the extended period (i.e. writing a product review is recorded as “Y”). Then, the dynamic credit-calculation module 13 further matches the behavior time t₀₁ of completing the specific shopping action by registered member A with the extended period M1 (i.e. different from the original period N1) for bonus profit of the purchased product to confirm whether the behavior time t₀₁ is still within the extended period M1. If the behavior time t₀₁ is still within the extended period M1, the dynamic credit-calculation module 13 further confirms registered members A and C are friends from the member relationship network R. Then, the dynamic credit-calculation module 13 calculates the bonus profit for registered member A y multiplying the price P1 of the product H1 with the merchandise profit ratio Y1% for the additional bonus profit (i.e. P1*Y1%). Accordingly, the dynamic credit-calculationmechanism using the extended period for a bonus profit may increase the usage rate of the network shopping system 1. Specifically, registered member A may gain a profit of P1*X1% in the period N1, and gain a bonus profit of P1*Y1% after writing a product review in the extended period M1 for the bonus profit.

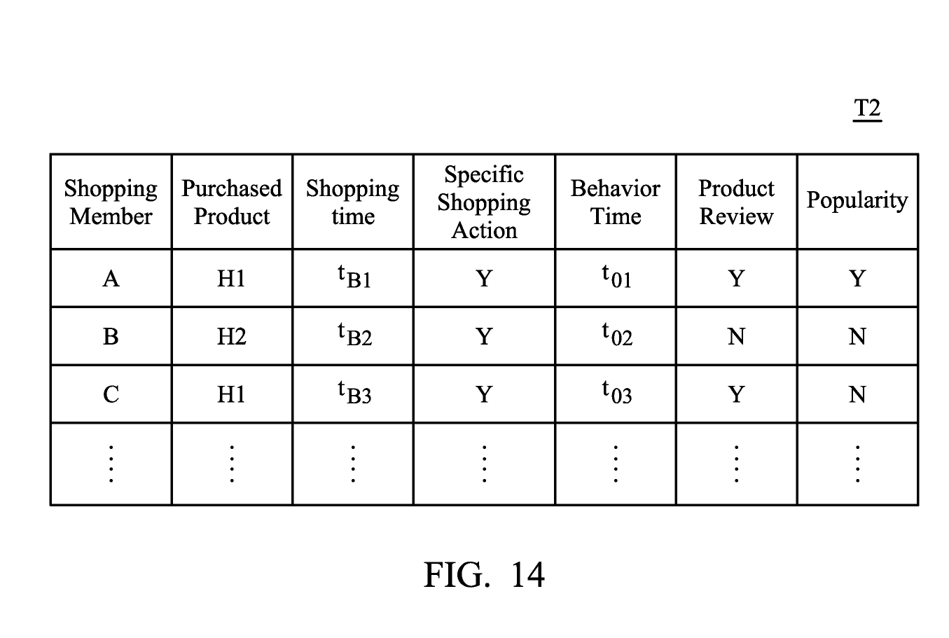

FIG. 13 is a diagram of a user interface of the network shopping system in accordance with a fourth embodiment of the invention. Referring to FIG. 13, in addition to recording whether the registered member has written a review of the purchased product, the product review recording unit 1016 further records the popularity of the written product review (i.e. the number of “agreements”). For example, the number of agreements for the product review written by registered member A is 175. FIG. 14 is yet another diagram of shopping record in accordance with an embodiment of the invention. Referring to FIG. 14, given that the threshold for the number of agreements is 100, the product review recording unit 1016 of the shopping recording module 101 will record the popularity of the product review by registered member A as “Y” since the number of agreements is 175 that exceeds the threshold of 100, and store the record “Y” in the shopping data table T2 via the shopping record generating unit 1015. When registered member C has completed his purchase of the product H1, the dynamic credit-calculation module 13 performs a calculation of the credit-calculation mechanism according to the merchandise data table T1, the member relationship network R, and the shopping data table T2. In the calculation, the dynamic credit-calculation module 13 knows that registered member A has also purchased the product H1 through the shopping data table T2, and registered member A is qualified to gain the profit of the purchased product H1 (i.e. the specific shopping action is recorded as “Y”), and is qualified to gain the bonus profit of the purchased product H1 in the extended period (i.e. writing a product review and popularity of the product review are recorded as “Y”). Then, the dynamic credit-calculation module 13 further matches the behavior time t₀₁ of completing the specific shopping action by registered member A with the extended period M1 (i.e. different from the original period N1) for bonus profit of the purchased product to confirm whether the behavior time t₀₁ is still within the extended period M1. If the behavior time t₀₁ is still within the extended period M1, the dynamic credit-calculation module 13 further confirms registered members A and C are friends from the member relationship network R. Then, the dynamic credit-calculation module 13 calculates the bonus profit for registered member A by multiplying the price P1 of the product H1 with the merchandise profit ratio Y1% for the additional bonus profit (i.e. P1*Y1%). Accordingly, the dynamic credit-calculation mechanism using the extended period for a bonus profit and an additional bonus profit ratio may increase the chances that the registered member writes a reference product review, thereby increasing the usage rate of the network shopping system 1.

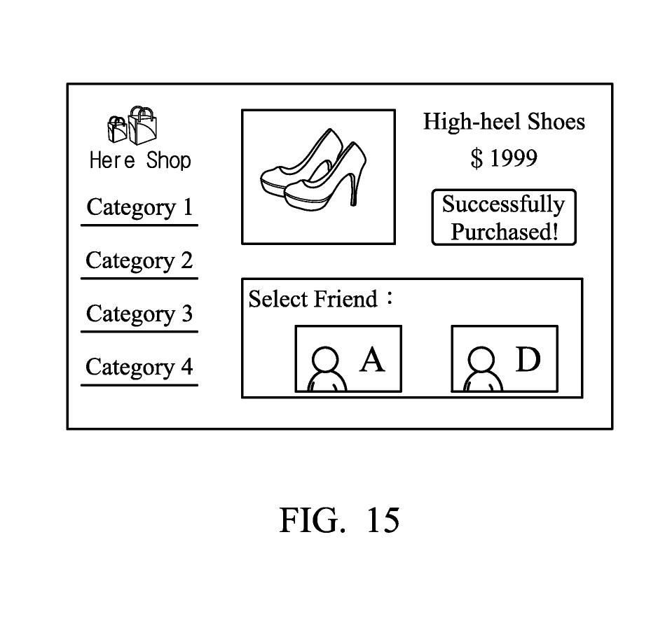

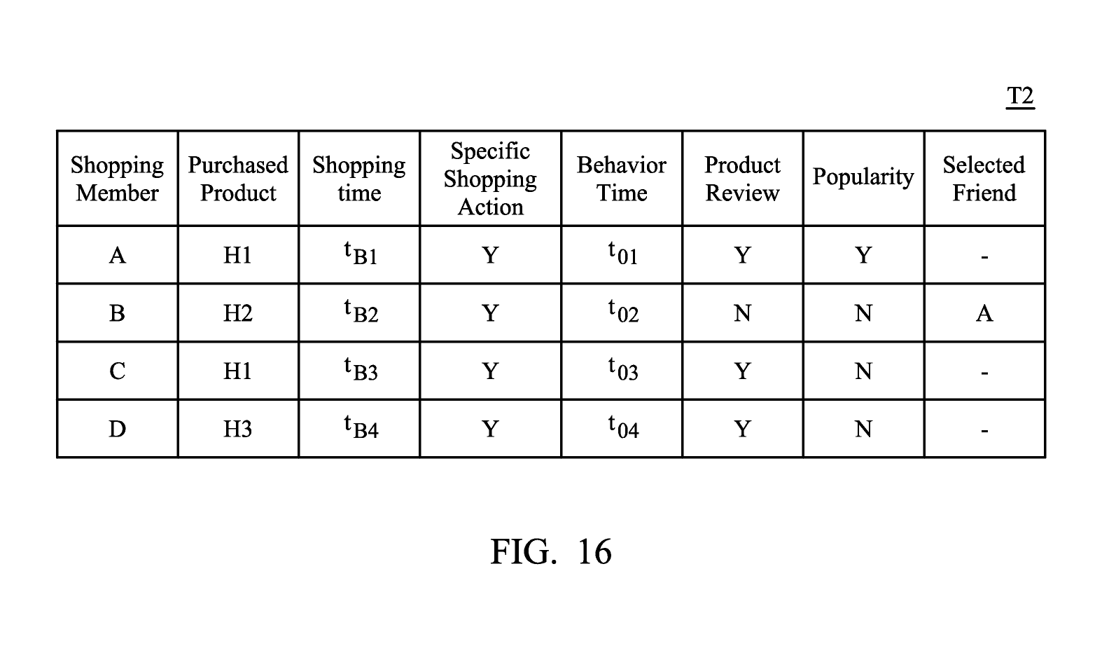

FIG. 15 is a diagram of a user interface of the network shopping system 1 in accordance with a fifth embodiment of the invention. Referring to FIGS. 1˜3 and FIG. 15, the dynamic credit-calculation module 13 further provides a function for the registered member to select the friends for sharing the merchandise profit. For example, when registered member B has completed his purchase of the product H1, the dynamic credit-calculation module 13 may know that registered members A and D are friends of registered member B through the member relationship network R, and thus the dynamic credit-calculation module 13 provides options for registered member A and registered member D, so that registered member B may actively select the provided options to share the merchandise profit. FIG. 16 is yet another diagram of a shopping record in accordance with an embodiment of the invention. Referring to FIG. 16, when registered member B selects registered member A to share the merchandise profit, the shopping recording module 101 will record the selected option of registered member B and update the selected option in the shopping data table T2. It should be noted that the number of selected registered members is not limited to 1, and it can be more than 1. In addition, the upper limit of the number of selected registered members can be preset by the administrator of the dynamic credit-calculation module 13. In a preferred embodiment, the upper limit of the number of selected registered members is determined by the total number of other registered members who are friends of the registered member (e.g. registered member B) and have completed the specific shopping action before the registered member. Accordingly, when the member relationship network R becomes more and more complicated, the aforementioned mechanism may raise the computation efficiency of the dynamic credit-calculation module 13 to reduce the computation time. It should be noted that the selected friends for sharing the merchandise profit is not bound forever, and the selected friends can be set by the administrator of the network shopping system 1 or alternated by the registered member.

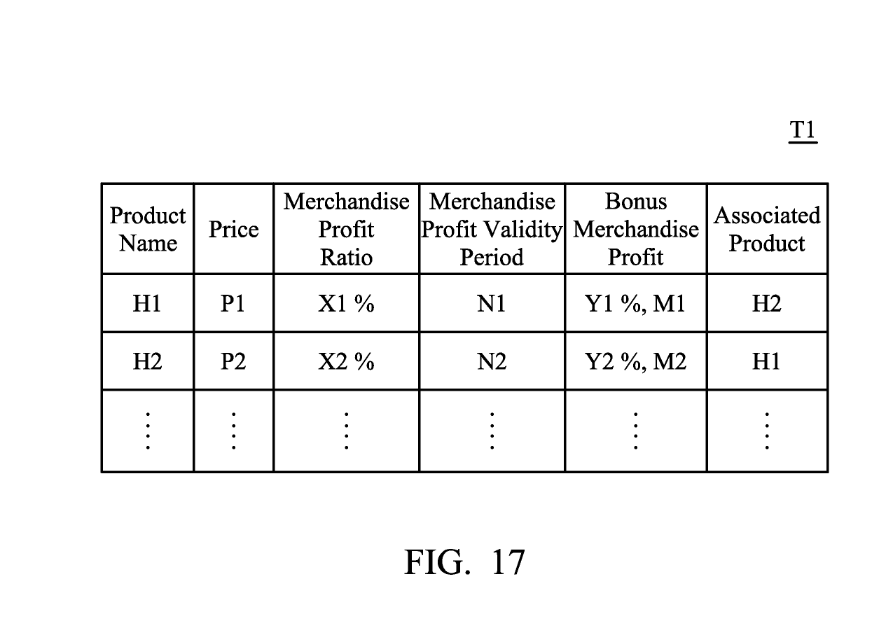

FIG. 17 is a diagram of a user interface in accordance with a sixth embodiment of the invention. Referring to FIGS. 1˜3 and FIG. 17, in addition to setting the configurations for sharing the profit of a single product by the seller, the seller is further capable of setting associated products via the merchandise profit setting module 122 of the merchandise management module 12. When other registered members have purchased one of the associated products, they are possibly qualified to share the merchandise profit of the associated purchased products. For example, when the column of the associated product of the product H1 is set to H2, it indicates that the product H2 is associated with the product H1. Referring to FIG. 16 again, when registered member B has purchased the product H2, the dynamic credit-calculation module 13 will consider that registered member B is qualified to share the merchandise profit of registered member A even though registered member A has purchased the product H1. The calculation and the credit-calculation mechanism can be referred to in the aforementioned embodiments, and the details will be omitted here. Accordingly, the seller may organize different combinations of associated products, thereby encouraging the user to buy products from a specific seller.

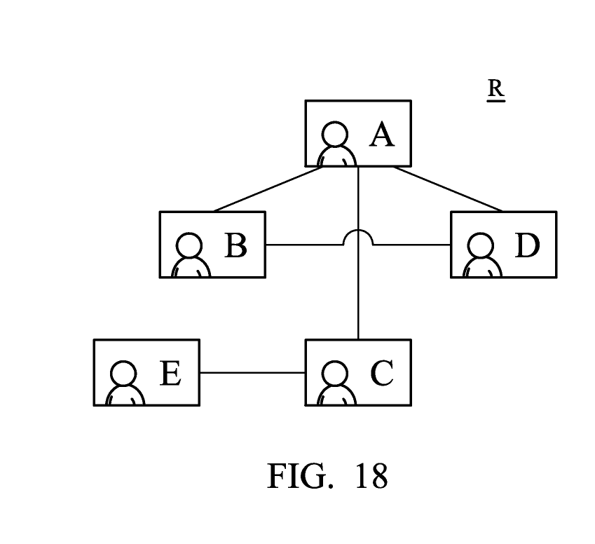

FIG. 18 is a diagram of a user interface in accordance with a seventh embodiment of the invention. Referring to FIGS. 1˜5 and FIG. 18, the member relationship network R further comprises multiple hierarchy levels such as level 1, level 2, level 3, etc. In addition, the hierarchy can be confirmed according to preset rules from the hierarchy network confirmation module 113. In a preferred embodiment, the preset rules may be the sequential order of the behavior time or shopping time of completing the specific shopping action of the same product, but the invention is not limited thereto. In addition, the number of registered members in each hierarchy level can be preset by the hierarchy network confirmation module 113. For example, registered member A has direct friends and indirect friends, where the hierarchy level of direct friends is 1, and the hierarchy level of indirect friend is larger than or equal to 2. As shown in FIG. 18, regarding registered member A, registered members B, C, and D are direct friends of registered member A. Registered member E is an indirect friend of registered member A, and has a hierarchy level of 2. Similarly, regarding registered member C, registered members A and E are direct friends of registered member C. Registered members B and D are indirect friends of registered member C, and have a hierarchy level of 2.

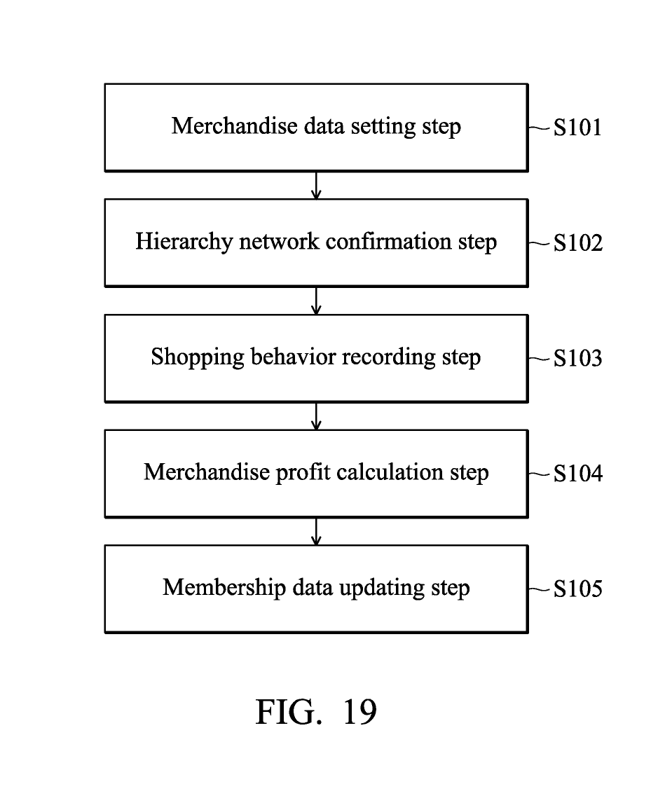

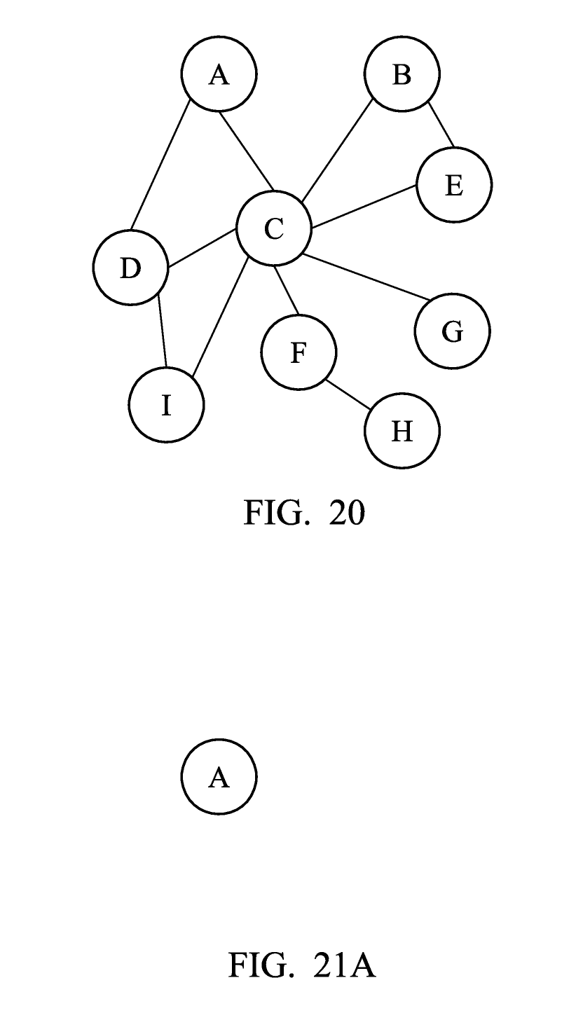

FIG. 19 is a flow chart of a method for implementing the credit-calculation mechanism in a network shopping system in accordance with an embodiment of the invention. Referring to FIGS. 1˜3 and FIG. 19, the method comprises the following steps.

In a merchandise data setting step S101, the network shopping system 1 receives merchandise data of at least one product for sale registered by the administrator via a merchandise registration interface, and receives a configuration of the merchandise profit of the product(s) for sale via a profit setting interface, thereby generating a merchandise data table comprising the merchandise data and the merchandise profit. For example, the seller may register detailed merchandise data of at least one product for sale via the merchandise posting setting module 121 of the merchandise management module 12, where the registered merchandise data may be the product picture, product name, price, category, and the posting time, but the invention is not limited thereto. After registration of the detailed merchandise data, the product for sale is posted on the merchandise shopping module 10 for browsing by the user. In addition, the merchandise profit ratio, validity period, and extended period of the product for sale can be set via the merchandise profit setting module 122 of the merchandise management module 12, thereby generating a merchandise data table T1 (e.g. FIG. 2 and FIG. 11) and storing the merchandise data table T1 into the merchandise database 123.

In a hierarchy network confirmation step S102, the network shopping system 1 analyzes and confirms friend relationship between a plurality of registered members of the network shopping system 1, and traverses a member relationship network. For example, a user may become a registered member of the network shopping system 1 by registering in the membership management module 11 of the network shopping system 1. In addition, the hierarchy network confirmation module 113 of the membership management module 11 analyzes the friend relationship between the registered members. For example, upon registration, a user may manually select registered members with whom he is friends (i.e. single-direction confirmation). The user may also select other registered members who are friends, and then the hierarchy network confirmation module 113 may send a friend relationship confirmation notification to the selected registered members. After confirmation is approved, the friend relationship between the selected registered member and the user is built in the node-edge format, and then the member relationship network R is built according to all the nodes and edges (i.e. double-direction confirmation). In addition, the hierarchy network confirmation module 113 may connect to external social networking website according to the social network data provided by the user, and analyze contacts of the user on the external social networking website to build the member relationship network R, but the invention is not limited thereto. After confirming friend relationships of the user, the hierarchy network confirmation module 113 records the friend relationship relations of the user in the node-edge format, and updates the member relationship network R in the membership database. Then, the hierarchy network confirmation module 113 may traverse the member relationship network R to analyze the friend relationship of each registered member.

In a shopping action recording step S103, the network shopping system 1 records the shopping data and a specific shopping action for purchasing a product for sale on the network shopping system 1 via a shopping interface, and generates the shopping data table according to the recorded shopping data and the specific shopping action. For example, when a registered member of the network shopping system has purchased a product for sale via the merchandise shopping module 10 and has completed a specific shopping action (e.g. publicizing the shopping information, sharing the shopping information, recommending the product for sale, or purchasing the product for sale, as shown in FIG. 6), the registered member is qualified to share the merchandise profit of the purchased product. In addition, if the registered member has further completed an additional shopping action (e.g. writing a product review in ratings or texts, as shown in FIG. 12), the registered member is further qualified to share the bonus merchandise profit of the purchased product. It should be noted that the shopping recording module 101 will record the shopping data and the shopping action of the registered member, and generate the shopping data table T2 (e.g. FIG. 5 and FIG. 10).

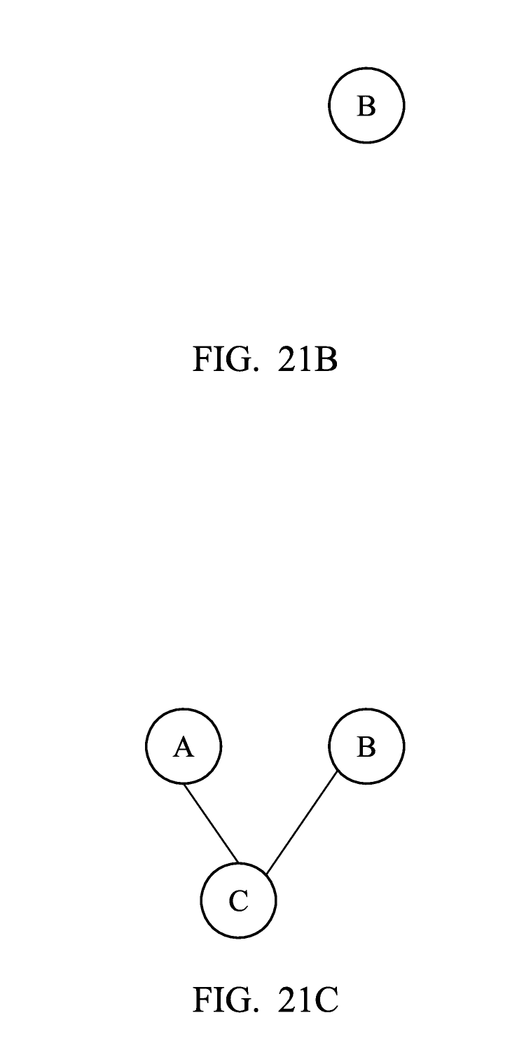

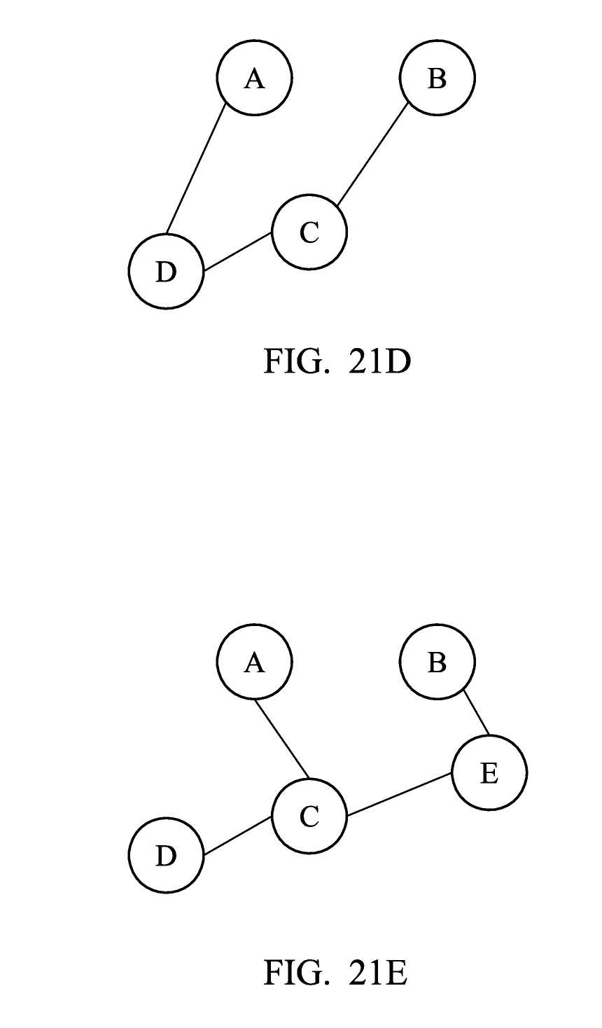

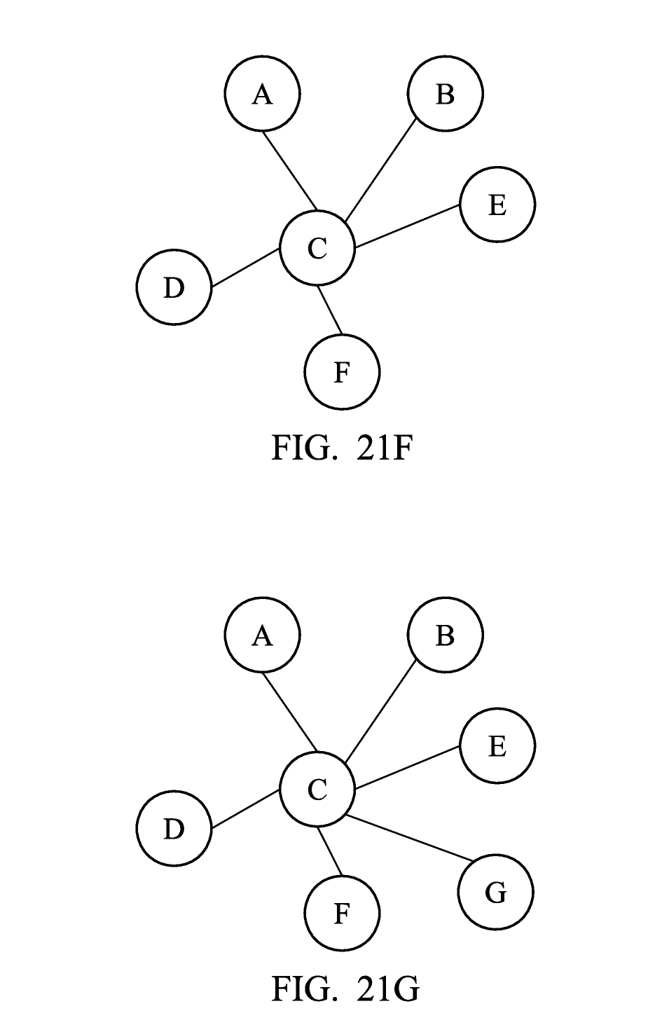

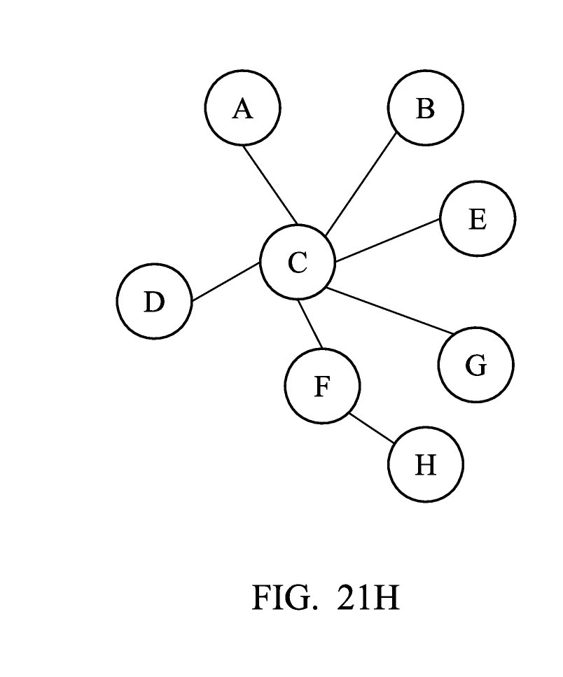

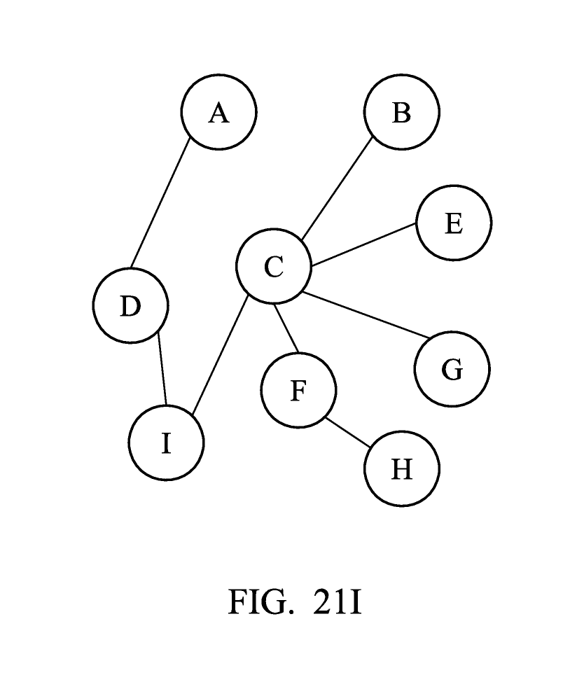

In a merchandise profit calculation step S104, a hierarchy network corresponding to the specific shopping action is determined from the member relationship network according to the shopping data table, the member relationship network, and the merchandise data table (e.g. the details can be referred to in FIG. 21A˜21I and Table 2). Then, the calculation of the credit for sharing the merchandise profit is performed according to the hierarchy network. For example, when a registered member has purchased a product for sale, the dynamic credit-calculation module 13 performs a calculation of the credit-calculation mechanism of the merchandise profit according to the merchandise data table T1, the member relationship network R, and the shopping data table T2. In addition, the dynamic credit-calculation module 13 further knows that other registered members have also purchased the same product through the shopping data table T2, and analyze whether each registered member is qualified to share the merchandise profit of the purchased product, and whether each registered member is qualified to share the bonus merchandise profit.

If the registered member is only qualified to share the merchandise profit of the purchased product, the behavior time t01 (as shown in FIG. 5) during which the registered member has completed the specific shopping action will be matched with the merchandise profit validity period N1 (as shown in FIG. 2) in the merchandise data table T1 to confirm whether the behavior time t11 is within the validity period N1. If the behavior time t01 is within the validity period N1, the dynamic credit-calculation module 13 further confirms the friend relationship relations of the registered member through the member relationship network R. Then, the dynamic credit-calculation module 13 calculates the shared merchandise profit (e.g. P1*X1%) of the registered member according to the merchandise data table T1, and distributes the shared merchandise profit to each qualified registered member. In addition, if the registered member is not only qualified to share the merchandise profit of the purchased product but also qualified to share the bonus merchandise profit, the dynamic credit-calculation module 13, the dynamic credit-calculation module 13 further matches the behavior time that the registered member has completed the specific shopping action (as shown in FIG. 10) with the extended period M1 (as shown in FIG. 11) for gaining the bonus merchandise profit to confirm whether the behavior time t01 is still within the extended period M1. If the behavior time t01 is within the extended period M1, the dynamic credit-calculation module 13 further confirms the friend relationship relations of the registered member through the member relationship network R, and then the dynamic credit-calculation module 13 further calculates the bonus merchandise profit (e.g. P1*Y1%) for the registered member according to the merchandise data table T1, and distributes the bonus merchandise profit to the qualified registered member.

A membership data updating step S105: After distributing the merchandise profit, the membership data updating module 114 of the membership management module 11 will update the membership data of the registered members who obtain the distributed merchandise profit, and store the updated membership data to the membership database 115. Then, the registered members can query the shared merchandise profit on the network shopping system 1 after logging in the network shopping system 1 via the membership login module 112.

Specifically, the network shopping system 1 generates a hierarchy network corresponding to each specific shopping action according to the hierarchy relationship between direct friends and indirect friends of each registered member. In addition, with appropriate conditions (e.g. the merchandise profit validity period, writing product reviews, extended period for bonus merchandise profit, etc.), the network shopping system 1 can more precisely and efficiently distribute the merchandise profit and/or bonus merchandise profit, that corresponds to each specific shopping action, to the qualified registered members. Furthermore, the dynamic credit-calculation module 13 further determines a hierarchy network corresponding to each specific shopping action from the member relationship network according to the shopping data table (e.g. FIG. 5 and FIG. 10), the member relationship network (e.g. FIG. 18), and the merchandise data table (e.g. FIG. 2), and calculates the credits for sharing the merchandise profit according to the hierarchy network. For example, the merchandise profit corresponding to each specific shopping action is distributed to qualified direct friends and qualified indirect friends of the registered members who have performed the corresponding specific shopping action, and then the distributed merchandise profit corresponding to each specific shopping action is summarized for each qualified registered member.

FIG. 20 is a diagram of the member relationship network in accordance with an embodiment of the invention. The diagram of friend relations between registered members A˜I of the network shopping system 1 is shown in FIG. 20. For example, registered member A has direct friends C and D, and indirect friends B, E, G, F, H, and I. Registered member C has direct friends A, B, D, E, F, G, and I, and has an indirect friend H. The direct friends and indirect friends of other registered members can be derived in a similar way. In an embodiment, the friend relationship of each registered member comprises direct hierarchy relationship (i.e. direct friends) and indirect hierarchy relationship (i.e. indirect friends), and the direct hierarchy relationship and indirect hierarchy relationship can be expressed by a hierarchy level. For example, the hierarchy level is 1 for the direct hierarchy relationship, and the friends in the hierarchy level of 1 are directly set and confirmed by the registered member. The hierarchy level for the indirect hierarchy relationship is larger than or equal to 2. For example, registered member C is a direct friend of registered member A, and registered member G is a direct friend of registered member C. Accordingly, registered member G is an indirect friend having a hierarchy level of 2 for registered member A. For one having ordinary skill in the art, it will be appreciated that the direct hierarchy relationship, indirect hierarchy relationship, and the corresponding hierarchy level can be derived from the member relationship network shown in FIG. 20.

FIGS. 21A˜21I are diagrams of the hierarchy network when registered members purchase the same product in accordance with an embodiment of the invention. In an embodiment, each time registered members A˜I purchase a product on the network shopping system 1, the merchandise shopping module 10 will record corresponding shopping information such as the shopping record number, purchaser, purchased product, qualification for sharing the merchandise profit, shopping time, and credit-calculation start time. In addition, the dynamic credit-calculation module 13 further analyzes the direct hierarchy relationship, the indirect hierarchy relationship, and a corresponding hierarchy level of each registered member, and determines the credit-calculation ratio according to the hierarchy level. Given that the merchandise profit is 5% of the price of the purchased product, the registered members in the hierarchy level 1, 2, 3, and 4 respectively obtain 50%, 25%, 15%, and 10% of the merchandise profit.

For ease of description, the order of the shopping time of the registered members is A, B, C, D, E, F, G, H, and I, and each registered member is willing to publicize his shopping information to his friends. The friends of a registered member are qualified to share the merchandise profit if they purchased the same product before the registered member did, and the number of registered members to share the merchandise profit is not limited. Table 1 is a shopping data table of the aforementioned embodiment, and Table 2 is a detailed profit sharing table for each qualified registered member.

TABLE 1

| | | | Qualified for | | Start credit- |
|---|---|---|---|---|---|
| Shopping | Purchasing | Purchased | profit | Shopping | calculation |
| record No. | Member | Product | sharing | time | time |
| 01 | A | P1 | Y | T_{BA} | T_{BA} |
| 02 | B | P1 | Y | T_{BB} | T_{BB} |
| 03 | C | P1 | Y | T_{BC} | T_{BC} |
| 04 | D | P1 | Y | T_{BD} | T_{BD} |
| 05 | E | P1 | Y | T_{BE} | T_{BE} |
| 06 | F | P1 | Y | T_{BF} | T_{BF} |
| 07 | G | P1 | Y | T_{BG} | T_{BG} |
| 08 | H | P1 | Y | T_{BH} | T_{BH} |
| 09 | I | P1 | Y | T_{BI} | T_{BI} |

TABLE 2

| | |
|---|---|
| C: P1->(A)_{L1}: (50% * 5%)/2 | G: P1->(C)_{L1}: (50% * 5%)/1 |
| C: P1->(B)_{L1}: (50% * 5%)/2 | G: P1->(A)_{L2}: (25% * 5%)/5 |
| | G: P1->(B)_{L2}: (25% * 5%)/5 |
| | G: P1->(D)_{L2}: (25% * 5%)/5 |
| | G: P1->(E)_{L2}: (25% * 5%)/5 |
| | G: P1->(F)_{L2}: (25% * 5%)/5 |
| D: P1->(A)_{L1}: (50% * 5%)/2 | H: P1->(F)_{L1}: (50% * 5%)/1 |
| D: P1->(C)_{L1}: (50% * 5%)/2 | H: P1->(C)_{L2}: (25% * 5%)/1 |
| D: P1->(B)_{L2}: (25% * 5%)/1 | H: P1->(A)_{L3}: (15% * 5%)/5 |
| | H: P1->(B)_{L3}: (15% * 5%)/5 |
| | H: P1->(D)_{L3}: (15% * 5%)/5 |
| | H: P1->(E)_{L3}: (15% * 5%)/5 |
| | H: P1->(G)_{L3}: (15% * 5%)/5 |
| E: P1->(B)_{L1}: (50% * 5%)/2 | I: P1->(C)_{L1}: (50% * 5%)/2 |
| E: P1->(C)_{L1}: (50% * 5%)/2 | I: P1->(D)_{L1}: (50% * 5%)/2 |
| E: P1->(A)_{L2}: (25% * 5%)/2 | I: P1->(A)_{L2}: (25% * 5%)/5 |
| E: P1->(D)_{L2}: (25% * 5%)/2 | I: P1->(B)_{L2}: (25% * 5%)/5 |
| | I: P1->(E)_{L2}: (25% * 5%)/5 |
| | I: P1->(F)_{L2}: (25% * 5%)/5 |
| | I: P1->(G)_{L2}: (25% * 5%)/5 |
| | I: P1->(H)_{L3}: (15% * 5%)/1 |
| F: P1->(C)_{L1}: (50% * 5%)/1 | |
| F: P1->(A)_{L2}: (25% * 5%)/4 | |
| F: P1->(B)_{L2}: (25% * 5%)/4 | |
| F: P1->(D)_{L2}: (25% * 5%)/4 | |
| F: P1->(E)_{L2}: (25% * 5%)/4 | |

Referring to FIG. 20, FIGS. 21A˜21I, Table 1, and Table 2, for example, in FIG. 21A, registered member A purchased the product P1 at time T_{BA}. There is only one piece of data (i.e. No. 1) in the shopping data table at this time. The dynamic credit-calculation module 13 determines that there is no friend to share the merchandise profit, and does not perform a calculation of the credit-calculation mechanism.

In FIG. 21B, registered member B purchased the product P1 at time T_{BB}, and there are two pieces of data (i.e. No. 1 and No. 2) in the shopping data table. The dynamic credit-calculation module 13 analyzes the shopping data table and friend relationship between registered members A and B, and then knows that there is no friend relationship between registered members A and B. Thus, the dynamic credit-calculation module 13 determines that there is no friend to share the merchandise profit, and does not perform a calculation of the credit-calculation mechanism.

In FIG. 21C, registered member C purchased the product P1 at time T_{BC}, and there are three pieces of data in the shopping data table such as No. 1, No. 2, and No. 3. The dynamic credit-calculation module 13 analyzes the shopping data table and the friend relationship between registered members A, B, and C. Meanwhile, the dynamic credit-calculation module 13 knows that registered members A and B are direct friends of registered member C, and registered members A and B have purchased the product P1 before registered member C did. Thus, registered members A and B are qualified to share the merchandise profit of the purchased product P1. Accordingly, the merchandise profit for the hierarchy level 1 is equally shared to registered member C's direct friends A and B, and each of registered members A and B obtains a merchandise profit of PRICE*(50%*5%)/2, as shown in Table 2.

Furthermore, given that the credit-calculation format in Table 2 is “C:P1−>(B)L1:(50%*5%)/2”, C indicates the registered member who performs this shopping action, and registered member C purchased the product P1. The merchandise profit of the purchased product P1 is shared to registered member B (i.e. recorded as (B)L1) in the hierarchy level 1, where the ratio to distribute the merchandise profit to registered member B is (50%*5%)/2. Other records in a similar format in Table 2 can be easily interpreted by one having ordinary skilled in the art, and thus the details will be omitted here.

In FIG. 21D, registered member D purchased the product P1 at time T_{BD}, and there are four pieces of data in the shopping data table such as No. 1˜No. 4. The dynamic credit-calculation module 13 analyzes the shopping data table and the friend relationship between registered members A˜D. Meanwhile, the dynamic credit-calculation module 13 knows that registered members A and C are direct friends of registered member D, and registered members A and C have purchased the product P1 before registered member D did. Thus, registered member D's direct friends A and B are qualified to share the merchandise profit of the purchased product P1. In addition, the dynamic credit-calculation module 13 further knows that registered member B is a direct friend of registered member C, and thus registered member B is regarded as an indirect friend of registered member D, and the corresponding hierarchy level is 2. Since registered members A˜C purchased the product P1 before registered member D did, registered members A˜C are qualified friends for sharing the merchandise profit in the shopping action performed by registered member D. It should be noted that there are two direct friends of registered member D (i.e. hierarchy level=1), and there is one indirect friend of registered member D (i.e. hierarchy level=2). Accordingly, each of registered members A and C can earn a profit of PRICE*(50%*5%)/2. Registered member B can earn a profit of PRICE*(25%*5%)/1.

In FIG. 21E, registered member E purchased the product P1 at time T_{BE}, and there are five pieces of data in the shopping data table such as No. 1˜No. 5. The dynamic credit-calculation module 13 analyzes the shopping data table and the friend relationship between registered members A˜E. Meanwhile, the dynamic credit-calculation module 13 knows that registered members B and C are direct friends of registered member E, and registered members B and C have purchased the product P1 before registered member E did. Thus, registered member E's direct friends B and C are qualified to share the merchandise profit of the purchased product P1. In addition, the dynamic credit-calculation module 13 further knows that registered members A and D are direct friends of registered member C, and thus registered members A and D can be regarded as indirect friends of registered member E, and the corresponding hierarchy level is 2. Since registered members A˜D have purchased the product P1 before registered member E did, registered members A˜D are qualified friends for sharing the merchandise profit in the shopping action performed by registered member E. It should be noted that there are two direct friends (i.e. B and C) of registered member E (i.e. hierarchy level=1), and there are two indirect friends (i.e. A and D) of registered member E (i.e. hierarchy level=2). Accordingly, each of registered members B and C can earn a profit of PRICE*(50%*5%)/2 in the shopping action performed by registered member E. Each of registered members A and D can earn a profit of PRICE*(25%*5%)/2 in the shopping action performed by registered member E.

In FIG. 21F, registered member F purchased the product P1 at time T_{BF}, and there are six pieces of data in the shopping data table such as No. 1˜No. 6. The dynamic credit-calculation module 13 analyzes the shopping data table and the friend relationship between registered members A˜F. Meanwhile, the dynamic credit-calculation module 13 knows that only registered member C is the direct friend of registered member F, and registered member C has purchased the product P1 before registered member F did. Thus, registered member F's direct friend C is qualified to share the merchandise profit of the purchased product P1. In addition, the dynamic credit-calculation module 13 further knows that registered members A, B, D, and E are direct friends of registered member C, and thus registered members A, B, D and E can be regarded as indirect friends of registered member F, and the corresponding hierarchy level is 2. Since registered members A˜E have purchased the product P1 before registered member F did, registered members A˜E are qualified friends for sharing the merchandise profit in the shopping action performed by registered member F. It should be noted that there is one direct friend (i.e. C) of registered member F (i.e. hierarchy level=1), and there are four indirect friends (i.e. A, B, D, and E) of registered member F (i.e. hierarchy level=2). Accordingly, registered member C can earn a profit of PRICE*(50%*5%)/1 in the shopping action performed by registered member F. Each of registered members A, B, D and E can earn a profit of PRICE*(25%*5%)/4 in the shopping action performed by registered member F.

In FIG. 21G, registered member G purchased the product P1 at time T_{BG}, and there are seven pieces of data in the shopping data table such as No. 1˜No. 7. The dynamic credit-calculation module 13 analyzes the shopping data table and the friend relationship between registered members A˜G. Meanwhile, the dynamic credit-calculation module 13 knows that only registered member C is the direct friend of registered member G, and registered member C has purchased the product P1 before registered member G did. Thus, registered member G's direct friend C is qualified to share the merchandise profit of the purchased product P1. In addition, the dynamic credit-calculation module 13 further knows that registered members A, B, D, E and F are direct friends of registered member C, and thus registered members A, B, D, E and F can be regarded as indirect friends of registered member G, and the corresponding hierarchy level is 2. Since registered members A˜F have purchased the product P1 before registered member G did, registered members A˜F are qualified friends for sharing the merchandise profit in the shopping action performed by registered member G. It should be noted that there is one direct friend (i.e. C) of registered member G (i.e. hierarchy level=1), and there are five indirect friends (i.e. A, B, D, E, and F) of registered member G (i.e. hierarchy level=2). Accordingly, registered member C can earn a profit of PRICE*(50%*5%)/1 in the shopping action performed by registered member G. Each of registered members A, B, D, E and F can earn a profit of PRICE*(25%*5%)/5 in the shopping action performed by registered member G.

In FIG. 21H, registered member H purchased the product P1 at time T_{BH}, and there are eight pieces of data in the shopping data table such as No. 1˜No. 8. The dynamic credit-calculation module 13 analyzes the shopping data table and the friend relationship between registered members A˜H. Meanwhile, the dynamic credit-calculation module 13 knows that only registered member F is the direct friend of registered member H, and registered member F purchased the product P1 before registered member H did. Thus, registered member H's direct friend F is qualified to share the merchandise profit of the purchased product P1. In addition, the dynamic credit-calculation module 13 further knows that registered member C is a direct friend of registered member F, and thus registered member C can be regarded as an indirect friend of registered member H, and the corresponding hierarchy level is 2. In addition, since registered members A, B, D, E, and F are direct friends of registered member C, registered members A, B, D, E, and F can be regarded as indirect friends of registered member H, and the corresponding hierarchy level is 3. Since registered members A˜G have purchased the product P1 before registered member H did, registered members A˜G are qualified friends for sharing the merchandise profit in the shopping action performed by registered member H.

It should be noted that there is one direct friend (i.e. F) of registered member H (i.e. hierarchy level=1), and there is one indirect friend (i.e. C) of registered member H in the hierarchy level 2, and there are five indirect friends (i.e. A, B, D, E, G) of registered member H in the hierarchy level 3. Accordingly, registered member F can earn a profit of PRICE*(50%*5%)/1 in the shopping action performed by registered member H. Registered member C can earn a profit of PRICE*(25%*5%)/1 in the shopping action performed by registered member H. Each of registered members A, B, D, E and G can earn a profit of PRICE*(15%*5%)/5 in the shopping action performed by registered member H.

In FIG. 21I, registered member I purchased the product P1 at time T_{BI}, and there are nine pieces of data in the shopping data table such as No. 1˜No. 9. The dynamic credit-calculation module 13 analyzes the shopping data table and the friend relationships between registered members A˜H. Meanwhile, the dynamic credit-calculation module 13 knows that registered members C and D are direct friends of registered member I, and registered members C and D have purchased the product P1 before registered member I did. Thus, registered member H's direct friends C and D are qualified to share the merchandise profit of the purchased product P1. In addition, the dynamic credit-calculation module 13 further knows that registered member A is a direct friend of registered member D, and registered members B, E, F, and G are direct friends of registered member C, and thus registered members A, B, E, F, and G can be regarded as indirect friends of registered member I, and the corresponding hierarchy level is 2. Since registered members A, B, E, F, and G have purchased the product P1 before registered member I did, registered members A, B, E, F, and G are qualified friends for sharing the merchandise profit in the shopping action performed by registered member I.

In addition, since registered member H is a direct friend of registered member F, registered member H can be regarded as an indirect friend of registered member I, and the corresponding hierarchy level is 3. Since registered member H has purchased the product P1 before registered member I did, registered member H is qualified to share the merchandise profit in the shopping action performed by registered member I. It should be noted that there are two direct friends (i.e. C and D) of registered member I (i.e. hierarchy level=1), and there are five indirect friends (i.e. C) of registered member I in the hierarchy level 2, and there is one indirect friend (i.e. H) of registered member I in the hierarchy level 3. Accordingly, each of registered members C and D can earn a profit of PRICE*(50%*5%)/2 in the shopping action performed by registered member I. Each of registered members A, B, E, F, and G can earn a profit of PRICE*(25%*5%)/5 in the shopping action performed by registered member I. Registered member H can earn a profit of PRICE*(15%*5%)/1 in the shopping action performed by registered member I.

In the aforementioned embodiment, the credit-calculation start time is set to the shopping time in the shopping data table recorded by the merchandise shopping module 12. Each registered member or the administrator of the network shopping system 1 may manually set the credit-calculation start time according to practical conditions or activities being held. It should be noted that the order for purchasing the product P1 is from A to I in the aforementioned embodiment. Accordingly, when registered member D purchased the product P1 at time TBD and the credit-calculation start time is set to the shopping time, only the registered members who purchased the product P1 before registered member D did is qualified to share the merchandise profit of the product P1. Specifically, the registered members in the hierarchy level n+1 are qualified to share the merchandise profit of the purchased product when the shopping time of the registered members in the hierarchy level n+1 is earlier than that of the registered member currently purchasing the product. The credit-calculation for other registered members can be calculated in a similar way.

In another embodiment, the dynamic credit-calculation module 13 repeatedly analyzes all shopping records in the shopping data table, and lists other registered members who have purchased the same product before the current purchaser did. When the listed registered members purchased the same product before other registered members did and have friend relationship with other registered members, the listed registered members are qualified to share the merchandise profit. For example, referring to FIG. 20, Table 1, and Table 2, the order of purchasing the product P1 is also from A to I. In the scenario of FIGS. 21A˜21I, since the credit-calculation start time is set to the shopping time, only the registered members who purchased the same product P1 before the credit-calculation time of the current shopping record are qualified to share the merchandise profit of the purchased product P1. However, in the embodiment, the dynamic credit-calculation module 13 will repeatedly analyze all shopping records in the shopping data table, and derive direct friends, indirect friends, and corresponding hierarchy levels for each registered member as a node. The result for distributing the merchandise profit to the qualified registered members is shown in Table 2.

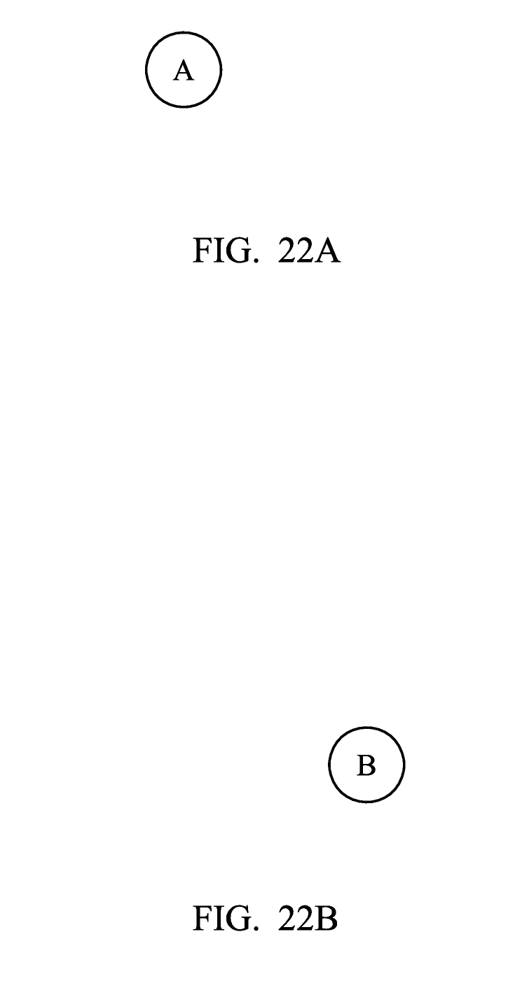

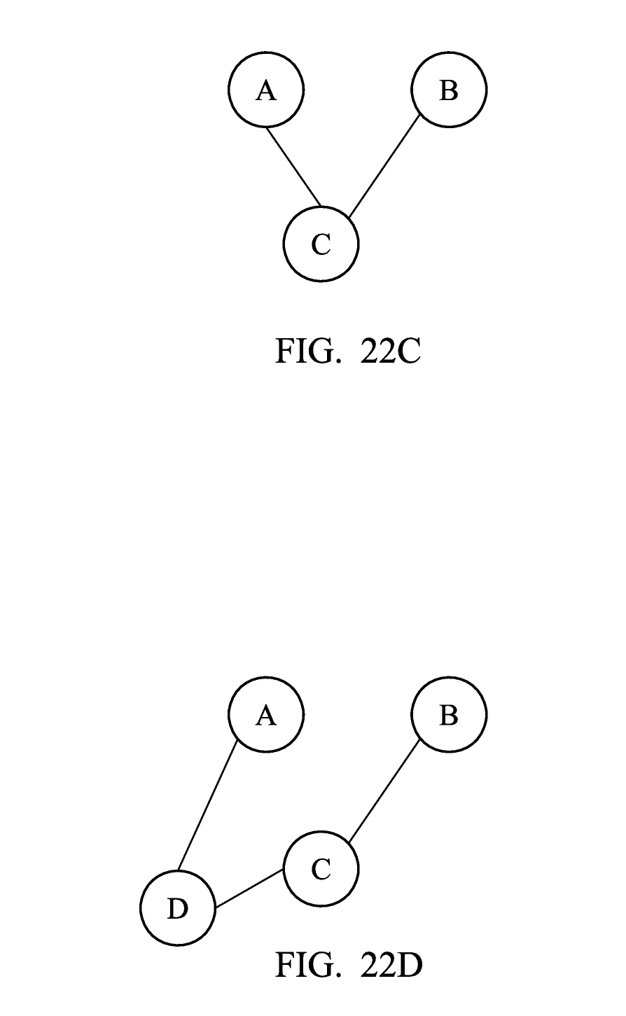

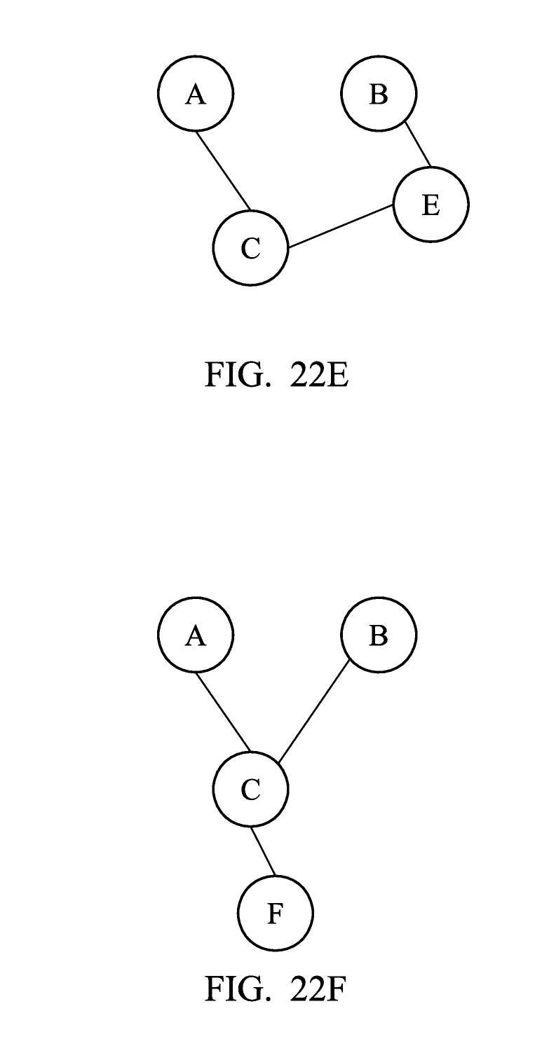

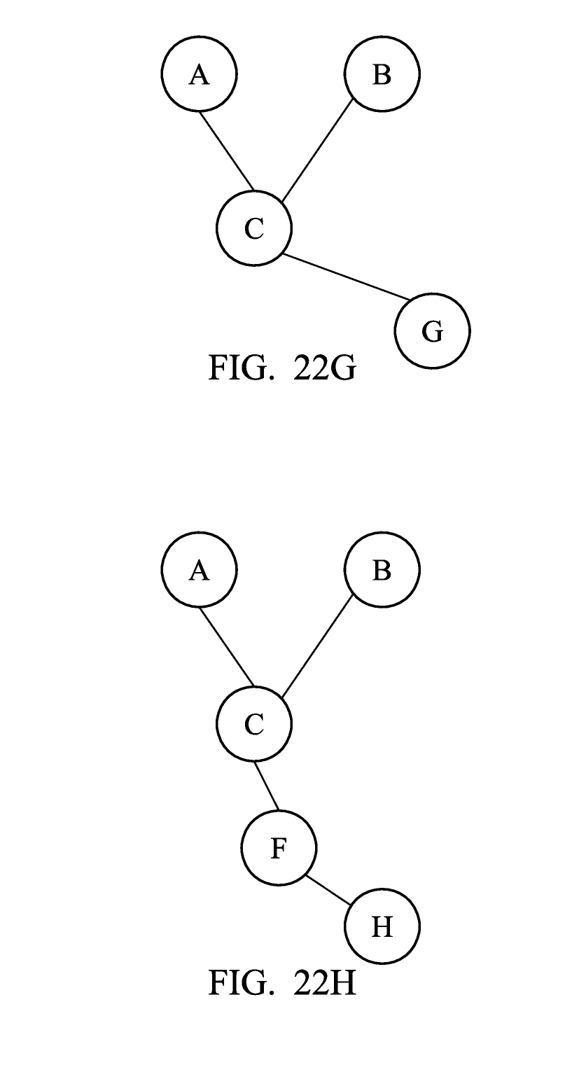

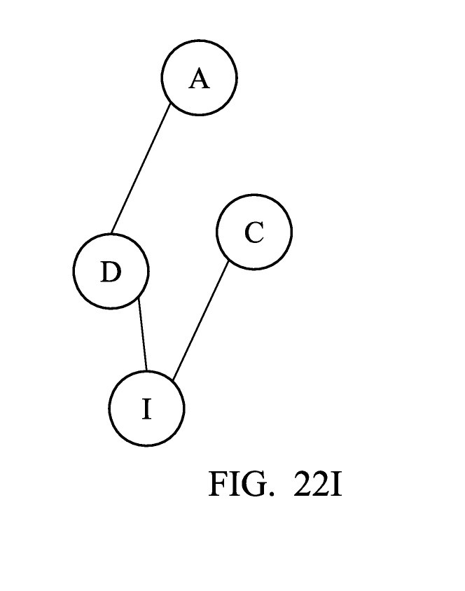

FIGS. 22A˜22I are diagrams of the hierarchy network when registered members purchase the same product in accordance with another embodiment of the invention. Table 1 is used again in the embodiment as the shopping data table, and Table 3 shows the detailed credit-calculation results in the embodiment.

TABLE 3

| | |
|---|---|
| C: P1->(A)_{L1}: (50% * 5%)/2 | G: P1->(C)_{L1}: (50% * 5%)/1 |
| C: P1->(B)_{L1}: (50% * 5%)/2 | G: P1->(A)_{L2}: (25% * 5%)/2 |
| | G: P1->(B)_{L2}: (25% * 5%)/2 |
| D: P1->(A)_{L1}: (50% * 5%)/2 | H: P1->(F)_{L1}: (50% * 5%)/1 |
| D: P1->(C)_{L1}: (50% * 5%)/2 | H: P1->(C)_{L2}: (25% * 5%)/1 |
| D: P1->(B)_{L2}: (25% * 5%)/1 | H: P1->(A)_{L3}: (15% * 5%)/2 |
| | H: P1->(B)_{L3}: (15% * 5%)/2 |
| E: P1->(B)_{L1}: (50% * 5%)/2 | I: P1->(C)_{L1}: (50% * 5%)/2 |
| E: P1->(C)_{L1}: (50% * 5%)/2 | I: P1->(D)_{L1}: (50% * 5%)/2 |
| E: P1->(A)_{L2}: (25% * 5%)/1 | I: P1->(A)_{L2}: (25% * 5%)/2 |
| | I: P1->(B)_{L2}: (25% * 5%)/2 |
| F: P1->(C)_{L1}: (50% * 5%)/1 | |
| F: P1->(A)_{L2}: (25% * 5%)/2 | |
| F: P1->(B)_{L2}: (25% * 5%)/2 | |

In yet another embodiment, the credit-calculationmechanism can be limited to the qualified direct friends of a specific registered member who is capable of influencing the purchasing decision of the specific registered member. In addition, the dynamic credit-calculation module 13 further considers whether the direct friends of a specific registered member's direct friends may influence the purchasing decision of the specific registered member. For example, the order for purchasing the product P1 is still from A to I, and the shopping data table is shown in Table 1. After registered members A˜D have purchased the product P1, the result for sharing the merchandise profit is the same with the embodiments of FIGS. 21A˜21D. In addition, the dynamic credit-calculation module 13 may keep the previously built relationship tree associated with each shopping action. For example, in FIG. 22C, the dynamic credit-calculation module 13 has built a relationship tree between registered member C and registered members A and B. Then, in FIG. 22D, registered member D has purchased the product P1, and the dynamic credit-calculation module 13 reuses the relationship tree in FIG. 22C and considers the relationship between the registered D and his direct friends A and C. That is, the relationship tree in FIG. 22C is reused, and registered member D and registered members A and C are directly connected in the relationship tree in FIG. 22D. Meanwhile, although registered members A and C are direct friends, registered members A and C are also direct friends of registered member D. Accordingly, the direct friend relationship between registered members A and C is not considered for registered member D in FIG. 22D.

In FIG. 22E, registered member E has purchased the product P1. Since registered members B and C are direct friends of registered member E and have purchased the product P1 before registered member E did, registered members B and C may influence the purchasing decision of registered member E. In addition, registered member A has purchased the product P1 before registered member C did, and thus registered member A may directly influence the purchasing decision of registered member C, and indirectly influence the purchasing decision of registered member E as well. It should be noted that registered member D is not considered in this case because the shopping time of registered member D is later than that of registered member C. Accordingly, registered member D cannot influence the purchasing decision of registered member C, and thus registered member D is not considered in the relationship tree in FIG. 22E. Meanwhile, each of registered members B and C can earn a profit of PRICE*(50%*5%)/2, and registered member A can earn a profit of PRICE*(25%*5%)/1.

Specifically, the registered members in the hierarchy level N+1 are qualified only when the shopping time of the registered members in the hierarchy level N+1 is earlier than that of the registered members in the hierarchy level N. That is, the registered members in the hierarchy level N+1 who have purchased the product P1 earlier may influence the purchasing decision of the registered members in the hierarchy level N who purchased the product P1 later. Similarly, one having ordinary skill in the art will appreciate that only the registered members who are capable of influencing the purchasing decision of the current purchaser are listed on the relationship trees shown in FIGS. 22F˜22I. The result for sharing the merchandise profit is shown in Table 3, and the details will be omitted here.

Furthermore, the hierarchy network traversed by the dynamic credit-calculation module 13 comprises the relationship trees in FIGS. 22A˜22I. When the dynamic credit-calculation module 13 is building a current relationship tree in an order from FIG. 22A to FIG. 22I, the previously built relationship trees will be kept, and the relationship trees will be reused when other registered members performs the same specific shopping action. For example, the relationship tree in FIG. 22D is built based on the relationship tree in FIG. 22C, and the relationship tree in FIG. 22E is built based on the relationship tree in FIG. 22D. Similarly, the hierarchy network can be generated after traversing the relationship trees in FIGS. 22A˜22I. Accordingly, the aforementioned method does not cause additional burden to the network shopping system 1 for analyzing possible friend relationship and associated shopping records of each registered member thoroughly, and the performance for calculating the credit-calculation mechanism can be improved.

In view of the above, a network shopping system having a credit-calculation mechanism is provided. The network shopping system comprises: a merchandise management module, configured to receive merchandise data of at least one product for sale and merchandise profit of the product registered by an administrator, and generate a merchandise data table comprising the merchandise data and the merchandise profit; a membership management module, configured to analyze and confirm friend relationships between a plurality of registered members of the network shopping system, and traverse a member hierarchy network according to the friend relationship between the registered members; a merchandise shopping module, information-linked with the merchandise management module and the membership management module, and configured to receive shopping data and a specific shopping action when the registered members purchase the product, and generate a shopping data table comprising the shopping data and the specific shopping action; and a dynamic credit-calculation module, information-linked with the merchandise management module, the membership management module, and the merchandise shopping module, wherein the dynamic credit-calculation module determines a hierarchy network corresponding to the specific shopping action from the membership hierarchy network, and performs a calculation of credits for distributing the merchandise profit of the purchased product according to the hierarchy network.

A method for implementing a credit-calculation mechanism in a network shopping system is further provided. The method comprises: a merchandise data setting step, a hierarchy network confirmation step, a shopping action recording step, and a merchandise profit calculation step. The merchandise data setting step comprises the steps of: receiving merchandise data of at least one product for sale registered by an administrator via a merchandise registration interface of the network shopping system; receiving settings of merchandise profit of the product for sale via a merchandise profit setting interface of the network shopping system; and generating a merchandise data table comprising the merchandise data and the merchandise profit. The hierarchy network confirmation step comprises the steps of: analyzing and confirming friend relationships between a plurality of registered members of the network shopping system via the network shopping system; and traversing a membership hierarchy network according to the confirmed friend relationship. The shopping action recording step comprises the steps of: recording shopping data and a specific shopping action of the registered members who purchased the product for sale on the network shopping system via a shopping interface of the network shopping system; and generating a shopping data table according to the shopping data and the specific shopping action. The merchandise profit calculation step comprises: determining a hierarchy network corresponding to the specific shopping action from the membership hierarchy network according to the shopping data table, the membership hierarchy network, and the merchandise data table; and calculating credits for sharing the merchandise profit according to the hierarchy network.

In addition, in the aforementioned method, the sellers set up the details of the merchandise for sale via the merchandise posting setting unit of the merchandise management module to post the merchandise on the network shopping system 1, and set up the merchandise profit ratio, the merchandise profit validity period, and bonus merchandise profit via the merchandise profit setting unit to generate the merchandise data table. Furthermore, the user may register in the network shopping system via the membership management module. The hierarchy network confirmation module of the management module analyzes and confirms the friend relationships of the registered members, thereby generating the member hierarchy network. When the registered members purchase products for sale via the merchandise shopping module and has completed a specific shopping action such as publicizing the shopping information, the registered members are qualified to share the merchandise profit of the purchased product. The shopping data and the shopping actions are recorded by the shopping recording module of the merchandise shopping module to generate the shopping data table. When other registered members purchased the same product, the dynamic credit-calculation module will perform calculation of credits for distributing the merchandise profit of the purchased product according to the shopping data table, the membership hierarchy network, the merchandise profit ratio, and the merchandise profit validity period, and distribute the credits to the qualified registered members.

In addition, when the registered member has completed a specific shopping action and completed an additional shopping action such as writing a product review, the registered member is qualified to share the bonus merchandise profit of the purchased profit. When another registered member has purchased the same product, the dynamic credit-calculation module performs calculation of credits for distributing the merchandise profit according to the shopping data table, the membership hierarchy network, the bonus merchandise profit, and distributes the credits to the qualified registered members. In other words, the merchandise credit-calculation mechanism in the invention can be dynamically adjusted according to the specific shopping action and the additional shopping action. Accordingly, the network shopping system and associated implementation method are capable of dynamically adjusting the conditions for distributing the merchandise profit according to the membership hierarchy network of the registered members and their shopping actions.

The methods, or certain aspects or portions thereof, may take the form of a program code embodied in tangible media, such as floppy diskettes, CD-ROMs, hard drives, or any other machine-readable (e.g., computer-readable) storage medium, or computer program products without limitation in external shape or form thereof, wherein, when the program code is loaded into and executed by a machine, such as a computer, the machine thereby becomes an apparatus for practicing the methods. The methods may also be embodied in the form of a program code transmitted over some transmission medium, such as an electrical wire or a cable, or through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of the preferred embodiments, it is to be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A network shopping system having a credit-calculationmechanism, comprising:
a merchandise management module, configured to receive merchandise data of at least one product for sale and merchandise profit of the product registered by an administrator, and generate a merchandise data table comprising the merchandise data and the merchandise profit;
a membership management module, configured to analyze and confirm friend relationships between a plurality of registered members of the network shopping system, and traverse a member hierarchy network in association with the friend relationships between the registered members;
a merchandise shopping module, information-linked with the merchandise management module and the membership management module, and configured to receive shopping data and a specific shopping action and generate a shopping data table comprising the shopping data and the specific shopping action in response to purchasing the product from the registered member; and
a dynamic credit-calculation module, information-linked with the merchandise management module, the membership management module, and the merchandise shopping module, the dynamic credit-calculation module determining a hierarchy network corresponding to the specific shopping action from the membership hierarchy network, and performing a credit-calculation mechanism for distributing the merchandise profit of the purchased product in association with the member hierarchy network.

2. The network shopping system as claimed in claim 1, wherein the merchandise management module comprises:
a merchandise-posting setting unit, configured to set up the merchandise data of the product for sale; and
a merchandise profit setting unit, configured to set up a merchandise profit ratio and a merchandise profit validity period for the merchandise profit of the product for sale, wherein the merchandise data table comprises the merchandise profit ratio and the merchandise profit validity period.

3. The network shopping system as claimed in claim 1, wherein the hierarchy network comprises direct hierarchy relationship and indirect hierarchy relationship corresponding to each registered member.

4. The network shopping system as claimed in claim 3, wherein the dynamic credit-calculation module determines whether any other registered member has purchased the product before a credit-calculation start time, wherein when there is another registered member who has purchased the product, the dynamic credit-calculation module determines the qualified registered members in the specific shopping action according to the direct hierarchy relationship and the indirect hierarchy relationship.

5. The network shopping system as claimed in claim 4, wherein the direct hierarchy relationship and the indirect hierarchy relationship comprises a hierarchy level, and the dynamic credit-calculation module gradually increases the hierarchy level in the membership hierarchy network to determine the registered members who have already purchased the product before the credit-calculation start time, and set the registered members, who have a hierarchy level that is lower than a predetermined threshold and have purchased the product before the credit-calculation start time, as qualified to share the merchandise profit of the specific shopping action.

6. The network shopping system as claimed in claim 5, wherein the dynamic credit-calculation module further sets the merchandise profit ratio according to the hierarchy level.

7. The network shopping system as claimed in claim 5, wherein the dynamic credit-calculation further sets an upper limit of the registered members in each hierarchy level to share the merchandise profit for each hierarchy level.

8. The network shopping system as claimed in claim 3, wherein when the friend relationship of a specific registered member is changed and the specific registered member performs another specific shopping action on the network shopping system, the dynamic credit-calculation module dynamically re-generates the membership hierarchy network to obtain the updated direct hierarchy relationship and the updated indirect hierarchy relationship of the specific registered member, and re-calculates the merchandise profit distributed to the qualified registered members in the other specific shopping action.

9. The network shopping system as claimed in claim 3, wherein the direct hierarchy relationship and the indirect hierarchy relationship comprise a hierarchy level,
wherein when a specific registered member performs a specific shopping action on the network shopping system, the dynamic credit-calculation module gradually increases the hierarchy level in the membership hierarchy network and sets the registered members in the hierarchy level N+1, who have purchased the product before the shopping time of the specific shopping action by the registered members in the hierarchy level N, as qualified to share the merchandise profit of the specific shopping action.

10. The network shopping system as claimed in claim 9, wherein the dynamic credit-calculation module further builds a first relationship tree corresponding to the specific shopping action of the specific registered member according to the hierarchy relationship of the qualified registered members in the specific shopping action,
wherein when another specific registered member in the registered members performs the specific shopping action, the dynamic credit-calculation module further utilizes the first relationship tree to build a second relationship tree of the other specific registered member in the specific shopping action, wherein the hierarchy network comprises the first relationship tree and the second relationship tree.

11. The network shopping system as claimed in claim 2, wherein the merchandise profit setting unit of the merchandise management module is further configured to set up a bonus profit for the merchandise profit of the product for sale, and settings of the bonus profit comprise a bonus profit ratio and a bonus profit validity period.

12. The network shopping system as claimed in claim 1, wherein a hierarchy network confirmation module of the membership management module analyzes and confirms the friend relationships between the registered members according to the friend relationships set manually by the registered members, or social network data of the registered members, and generates the membership hierarchy network according to the confirmed friend relationship.

13. The network shopping system as claimed in claim 12, wherein when the registered members manually select their friend relationship via the membership management module, the membership management module sends a confirmation notification to the registered member in the selected friend relationship to confirm their friend relationship.

14. The network shopping system as claimed in claim 12, wherein the hierarchy network confirmation module receives a user command to increase or remove the friend relationship corresponding to the registered members in the membership hierarchy network.

15. The network shopping system as claimed in claim 1, wherein the shopping data comprises a purchasing member, a purchased product, and shopping time, and the merchandise shopping module further retrieves and records an additional shopping action of the registered members.

16. The network shopping system as claimed in claim 15, wherein the specific shopping action comprises publicizing the shopping information, sharing the shopping information, recommending the product for sale, purchasing the product for sale, and/or a combination thereof, and the additional shopping action comprises writing a product review, recording popularity of the product review, and/or a combination thereof.

17. The network shopping system as claimed in claim 16, wherein the dynamic credit-calculation module performs a calculation for sharing the merchandise of the purchased product according to the specific shopping action, the additional shopping action, the friend relationship in the member hierarchy network, and the merchandise data table.

18. A method for implementing a credit-calculationmechanism in a network shopping system, the method comprising:
a merchandise data setting step, comprising:
receiving merchandise data of at least one product for sale registered by an administrator via a merchandise registration interface of the network shopping system;
receiving settings of merchandise profit of the product for sale via a merchandise profit setting interface of the network shopping system; and
generating a merchandise data table comprising the merchandise data and the merchandise profit;
a hierarchy network confirmation step, comprising:
analyzing and confirming friend relationship between a plurality of registered members of the network shopping system via the network shopping system; and
traversing a membership hierarchy network according to the confirmed friend relationship;
a shopping action recording step, comprising:
recording shopping data and a specific shopping action of the registered member in response to purchasing the product for sale on the network shopping system from the register member via a shopping interface of the network shopping system; and
generating a shopping data table according to the shopping data and the specific shopping action; and
a merchandise profit calculation step, comprising:
determining a hierarchy network corresponding to the specific shopping action from the membership hierarchy network according to the shopping data table, the membership hierarchy network, and the merchandise data table; and
calculating credits for sharing the merchandise profit in association with the hierarchy network.

19. The method as claimed in claim 18, wherein the merchandise profit setting interface receives a merchandise profit ratio and a merchandise profit valid time of the merchandise profit of the product for sale.

20. The method as claimed in claim 18, wherein the merchandise profit setting interface further comprises settings of a bonus profit of the merchandise profit of the product for sale, and the settings of the bonus profit comprise a bonus profit ratio and a bonus profit valid time.

21. The method as claimed in claim 18, further comprising:
analyzing and confirming the friend relationship between the registered members according to the friend relationship set manually by the registered members, or social network data of the registered members via a membership management module of the network shopping system; and
generating the membership hierarchy network according to the confirmed friend relationship.

22. The method as claimed in claim 21, further comprising:
when the registered members manually select their friend relationship, the membership management module, sending a confirmation notification to the registered member in the selected friend relationship to confirm their friend relationship.

23. The method as claimed in claim 18, further comprising:
receiving a user command to increase or remove the friend relationship corresponding to the registered members in the membership hierarchy network.

24. The method as claimed in claim 18, wherein the shopping data comprises a purchasing member, a purchased product, and shopping time, and the method further comprises:
recording an additional shopping action of the registered member.

25. The method as claimed in claim 24, wherein the specific shopping action comprises publicizing the shopping information, sharing the shopping information, recommending the product for sale, purchasing the product for sale, and/or a combination thereof, and the additional shopping action comprises writing a product review, recording popularity of the product review, and/or a combination thereof.

26. The method as claimed in claim 25, further comprising:
performing calculation for sharing the merchandise of the purchased product according to the specific shopping action, the additional shopping action, the friend relationship in the member hierarchy network, and the merchandise data table.
